(19) United States
(12) Patent Application Publication
(10) Pub. No.: US 2018/0015667 A1
(43) Pub. Date: Jan. 18, 2018

(54) SOLID OBJECT SHAPING APPARATUS, CONTROL METHOD FOR SOLID OBJECT SHAPING APPARATUS, AND CONTROL PROGRAM FOR SOLID OBJECT SHAPING APPARATUS

(71) Applicant: Seiko Epson Corporation, Tokyo (JP)

(72) Inventors: Kohei UTSUNOMIYA, Matsumoto (JP); Satoshi YAMAZAKI, Matsumoto (JP)

(21) Appl. No.: 15/546,507

(22) PCT Filed: Jan. 15, 2016
(86) PCT No.: PCT/JP2016/000200

§ 371 Date: Jul. 26, 2017

(30) Foreign Application Priority Data
Feb. 19, 2015 (JP) 2015-030153

(51) Int. Cl. B29C 64/209; B29C 64/112; B29C 64/393; B33Y 10/00; B33Y 30/00; B33Y 50/02; B29K 105/00

(52) U.S. Cl. CPC B29C 64/209; B29C 64/112; B33Y 30/00; B29C 64/393; B33Y 10/00; B33Y 50/02; B29K 2105/0058; B29K 2995/0021

(57) ABSTRACT

A solid object shaping apparatus includes a head unit that can eject a plurality of types of liquids including a first liquid, and a second liquid having an amount of colorant components which is smaller than an amount of colorant components of the first liquid, and a curing unit, and a solid object is shaped by using the plurality of unit shaping bodies, and in which the unit shaping body can be formed in a plurality of formation modes including a first formation mode in which the first liquid is ejected from the head unit, a second formation mode in which the first liquid is ejected from the head unit, then the second liquid is ejected, and a third formation mode in which the second liquid is ejected from the head unit, then the first liquid is ejected.

### BACKGROUND

### Technical Field

The present invention relates to a solid object shaping apparatus, a control method for the solid object shaping apparatus, and a control program for the solid object shaping apparatus.

### Background Art

In recent years, various solid object shaping apparatuses such as 3D printers have been proposed. The solid object shaping apparatus forms a shaping layer by using unit shaping bodies which are formed in a voxel through ejection of a liquid such as ink, and shapes a solid object by laminating the shaping layers. In such a solid object shaping apparatus, various techniques of shaping a colored solid object have been proposed (for example, JP-A-2013-075390).

Meanwhile, in a solid object shaping apparatus which shapes a solid object as a set of unit shaping bodies, such as a 3D printer, a surface of the shaped solid object may be visually recognized as having irregularities. In a case where the irregularities of the surface of the solid object are observed, the shaped solid object is visually recognized as causing a rough texture lacking smoothness. In this case, there is a problem in that it is hard to shape a solid object having a shape with a smooth surface.

An advantage of some aspects of the invention is to provide a solid object shaping apparatus which can shape a solid object with no roughness by reducing the probability that irregularities may be visually recognized.

### SUMMARY

According to an aspect of the invention, there is provided a solid object shaping apparatus including a head unit that can eject a plurality of types of liquids including a first liquid, and a second liquid having an amount of colorant components which is smaller than an amount of colorant components of the first liquid; and a curing unit that cures the liquid ejected from the head unit, in which a unit shaping body is formed by using the cured liquid, and a solid object is shaped by using the plurality of unit shaping bodies, and in which the unit shaping body can be formed in a plurality of formation modes including a first formation mode in which the first liquid is ejected from the head unit, and thus the unit shaping body is formed by using the cured first liquid; a second formation mode in which the first liquid is ejected from the head unit, then the second liquid is ejected, and thus the unit shaping body is formed by using the cured first liquid and the cured second liquid; and a third formation mode in which the second liquid is ejected from the head unit, then the first liquid is ejected, and thus the unit shaping body is formed by using the cured second liquid and the cured first liquid.

According to the aspect of the invention, a solid object can be formed by using not only a unit shaping body (hereinafter, referred to as a “first unit shaping body”) formed in the first formation mode but also a unit shaping body (hereinafter, referred to as a “second unit shaping body”) formed in the second formation mode and a unit shaping body (hereinafter, referred to as a “third unit shaping body”) formed in the third formation mode. Whereas the first unit shaping body has a color (hereinafter, referred to as a “first color”) of the first liquid, and the second unit shaping body and the third unit shaping body include a portion (hereinafter, referred to as a “first portion”) having the first color, and a portion (hereinafter, referred to as a “second portion”) having a color (hereinafter, referred to as a “second color”) of the second liquid, which is more highly transparent than the first color. For this reason, a projection of irregularities of a surface of a solid object is formed of the second portion of the second unit shaping body or the third unit shaping body instead of being formed of the first unit shaping body, and thus a color of the projection can be made close to a transparent color. Consequently, it is possible to increase transparency of a color of the projection of the irregularities of the surface of the solid object and thus to reduce the possibility that the irregularities may be visually recognized. In other words, it is possible to shape the solid object having a smooth surface with less roughness.

According to the aspect of the invention, a direction of the second portion viewed from the first portion of the second unit shaping body is the opposite of a direction of the second portion viewed from the first portion of the third unit shaping body. For this reason, a projection at a location directed upward on a surface of a solid object is formed of a unit shaping body whose second portion is located on an upper side, of the second unit shaping body and the third unit shaping body. In contrast, a projection at a location directed downward on the surface of the solid object is formed of a unit shaping body whose second portion is located on a lower side, of the second unit shaping body and the third unit shaping body. Therefore, it is possible to minimize the possibility that irregularities of the surface of the solid object may be visually recognized. In other words, the second unit shaping body and the third unit shaping body are used separately depending on a shape of the solid object, and thus it is possible to reduce the possibility that the irregularities of the surface of the solid object may be visually recognized.

For example, chromatic ink or achromatic ink may be used as the first liquid, and, for example, clear ink may be used as the second liquid.

In the solid object shaping apparatus, preferably, the unit shaping body formed in the second formation mode or the third formation mode is provided with a first face which is formed by using the cured first liquid, and a second face which is an opposite face to the first face and is formed by using the cured second liquid, and the first face is adjacent to a unit shaping body which is formed in the first formation mode, and the second face constitutes a surface of the solid object.

According to the aspect, a projection of the irregularities of the surface of the solid object can be formed of the second portion. For this reason, it is possible to reduce the possibility that the irregularities of the surface of the solid object may be visually recognized.

According to the aspect, the second unit shaping body and the third unit shaping body are formed so that the first portion and the first unit shaping body are adjacent to each other. Therefore, the portion having the first color can be continuously formed in the solid object. In other words, the solid object can be shaped so that a shape with a smooth surface is visually recognized.

In the solid object shaping apparatus, preferably, the unit shaping body can be formed in a plurality of formation modes including a fourth formation mode in which the second liquid is ejected from the head unit, and thus the unit shaping body is formed using the cured second liquid, and the unit shaping body formed in the second formation mode or the third formation mode is provided with a first face which is formed using the cured first liquid, and a second face which is an opposite face to the first face and is formed using the cured second liquid. In addition, preferably, the first face is adjacent to a unit shaping body which is formed in the first formation mode, and the second face is adjacent to a unit shaping body which is formed in the fourth formation mode.

According to the aspect, the second unit shaping body and the third unit shaping body are formed so that the first portion and the first unit shaping body are adjacent to each other. Therefore, a portion having the first color can be continuously formed in the solid object. In other words, the solid object can be shaped so that a shape with a smooth surface is visually recognized.

According to the aspect, a unit shaping body (hereinafter, referred to as a “fourth unit shaping body”) formed in a fourth formation mode is provided on a surface side of a portion which includes at least one of the first unit shaping body, the second unit shaping body, and the third unit shaping body and is colored for representing a color of a solid object. For this reason, the colored portion of the solid object can be protected by a set of fourth unit shaping bodies . Consequently, it is possible to minimize the extent of deterioration over time in the color of the solid object.

In the solid object shaping apparatus, preferably, the solid object is shaped by laminating a shaping layer formed of the plurality of unit shaping bodies in an upper direction, a unit shaping body formed in the second formation mode is formed on an upper side of a unit shaping body formed in the first formation mode, and the unit shaping body formed in the first formation mode is formed on an upper side of a unit shaping body formed in the third formation mode.

According to the aspect, during shaping of the solid object, the first portion of the second unit shaping body is provided on the lower side of the second portion, and the first portion of the third unit shaping body is provided on the upper side of the second portion. In this aspect, the solid object is shaped so that the first portion of the second unit shaping body is vertically adjacent to the first unit shaping body, and the first portion of the third unit shaping body is vertically adjacent to the first unit shaping body. For this reason, the portion having the first color can be continuously formed in the solid object, and thus the solid object can be shaped so that a shape with a smooth surface is visually recognized.

In the solid object shaping apparatus, preferably, the solid object is shaped by laminating a shaping layer formed of the plurality of unit shaping bodies, and a unit shaping body formed in the second formation mode is not adjacent to a unit shaping body formed in the third formation mode.

According to the aspect, the solid object is shaped so that the second unit shaping body is not adjacent to the third unit shaping body in each shaping layer. For this reason, it is possible to prevent the portion having the first color from being discontinuously disposed due to the first portion of the second unit shaping body being adjacent to the second portion of the third unit shaping body, or the second portion of the second unit shaping body being adjacent to the first portion of the third unit shaping body.

According to another aspect of the invention, there is provided a control method for a solid object shaping apparatus which includes a head unit that can eject a plurality of types of liquids including a first liquid, and a second liquid having an amount of colorant components which is smaller than an amount of colorant components of the first liquid; and a curing unit that cures the liquid ejected from the head unit, and which forms a unit shaping body by using the cured liquid, and shapes a solid object by using the plurality of unit shaping bodies, the method including controlling the head unit so as to form the unit shaping body in a plurality of formation modes including a first formation mode in which the first liquid is ejected from the head unit, and thus the unit shaping body is formed using the cured first liquid; a second formation mode in which the first liquid is ejected from the head unit, then the second liquid is ejected, and thus the unit shaping body is formed using the cured first liquid and the cured second liquid; and a third formation mode in which the second liquid is ejected from the head unit, then the first liquid is ejected, and thus the unit shaping body is formed using the cured second liquid and the cured first liquid.

According to the aspect of the invention, a projection of irregularities of a surface of a solid object is formed of the second portion of the second unit shaping body or the third unit shaping body instead of being formed of the first unit shaping body. Consequently, it is possible to increase the transparency of a color of the projection of the irregularities of the surface of the solid object and thus to reduce the possibility that the irregularities may be visually recognized. In other words, it is possible to shape the solid object having a smooth surface with less roughness.

According to still another aspect of the invention, there is provided a control program for a solid object shaping apparatus which includes a head unit that can eject a plurality of types of liquids including a first liquid, and a second liquid having an amount of colorant components which is smaller than an amount of colorant components of the first liquid; a curing unit that cures the liquid ejected from the head unit; and a computer, and which forms a unit shaping body by using the cured liquid, and shapes a solid object by using the plurality of unit shaping bodies, the program causing the computer function as a control portion that controls the head unit so as to form the unit shaping body in any one of a plurality of formation modes including a first formation mode in which the first liquid is ejected from the head unit, and thus the unit shaping body is formed by using the cured first liquid; a second formation mode in which the first liquid is ejected from the head unit, then the second liquid is ejected, and thus the unit shaping body is formed by using the cured first liquid and the cured second liquid; and a third formation mode in which the second liquid is ejected from the head unit, then the first liquid is ejected, and thus the unit shaping body is formed by using the cured second liquid and the cured first liquid.

According to the aspect of the invention, a projection of irregularities of a surface of a solid object is formed of the second portion of the second unit shaping body or the third unit shaping body instead of being formed of the first unit shaping body. Consequently, it is possible to increase the transparency of a color of the projection of the irregularities of the surface of the solid object and thus to reduce the possibility that the irregularities may be visually recognized. In other words, it is possible to shape the solid object having a smooth surface with less roughness.

### BRIEF DESCRIPTION OF DRAWINGS

FIG. 1 is a block diagram illustrating a configuration of a solid object shaping system 100 according to an embodiment of the invention.

FIGS. 2A-2E are diagrams for explaining shaping of a solid object Obj in the solid object shaping system 100.

FIG. 3 is a schematic sectional view of a solid object shaping apparatus 1.

FIG. 4 is a schematic sectional view of a recording head 30.

FIG. 5A is a diagram for explaining an operation of an ejecting portion D when a driving signal Vin is supplied.

FIG. 5B is a diagram for explaining an operation of an ejecting portion D when a driving signal Vin is supplied.

FIG. 5C is a diagram for explaining an operation of an ejecting portion D when a driving signal Vin is supplied.

FIG. 6 is a plan view illustrating an arrangement example of nozzles N in the recording head 30.

FIG. 7 is a block diagram illustrating a configuration of a driving signal generation portion 31.

FIG. 8 is a diagram illustrating the content of a selection signal Sel.

FIG. 9 is a timing chart illustrating a waveform of a driving waveform signal Com.

FIG. 10 is a flowchart illustrating a data generation process and a shaping process.

FIG. 11A is a diagram for explaining a solid object Obj.

FIG. 11B is a diagram for explaining a solid object Obj.

FIG. 12 is a flowchart illustrating a shape complementing process.

FIG. 13 is a flowchart illustrating a designation data generation process.

FIG. 14A is a diagram for explaining the type of block BL.

FIG. 14B is a diagram for explaining the type of block BL.

FIG. 14C is a diagram for explaining the type of block BL.

FIG. 15A is a diagram for explaining a relationship between an outer face voxel Vx-SF and an outer surface SF.

FIG. 15B is a diagram for explaining a relationship between an outer face voxel Vx-SF and an outer surface SF.

FIG. 15C is a diagram for explaining a relationship between an outer face voxel Vx-SF and an outer surface SF.

FIG. 15D is a diagram for explaining a relationship between an outer face voxel Vx-SF and an outer surface SF.

FIG. 16 is a diagram for explaining a relationship between a filling proportion RF and the type of block BL.

FIG. 17A is a diagram for explaining a relationship between shaping body data FD and designation data SD.

FIG. 17B is a diagram for explaining a relationship between shaping body data FD and designation data SD.

FIG. 18 is a diagram for explaining an edge block BL-EG.

FIG. 19 is a flowchart illustrating a data generation process and a shaping process related to Modification Example 6.

FIGS. 20A-20F are diagrams for explaining shaping of a solid object Obj in a solid object shaping system 100 related to Modification Example 6.

### DETAILED DESCRIPTION

Hereinafter, an embodiment of the invention will be described with reference to the drawings. However, a dimension and a scale of each part are different from actual ones as appropriate in each drawing. The embodiment described below is a preferred specific example of the invention and is thus added with technically preferred various limitations, but the scope of the invention is not limited to such an embodiment unless description for limiting the invention is made in the following description.

### A. EMBODIMENT

In the present embodiment, as a solid object shaping apparatus, a description will be made by exemplifying an ink jet type solid object shaping apparatus which ejects curable ink (an example of a “liquid”) such as resin ink containing resin emulsion or ultraviolet curable ink so as to shape a solid object Obj.

1. Configuration of Solid Object Shaping System

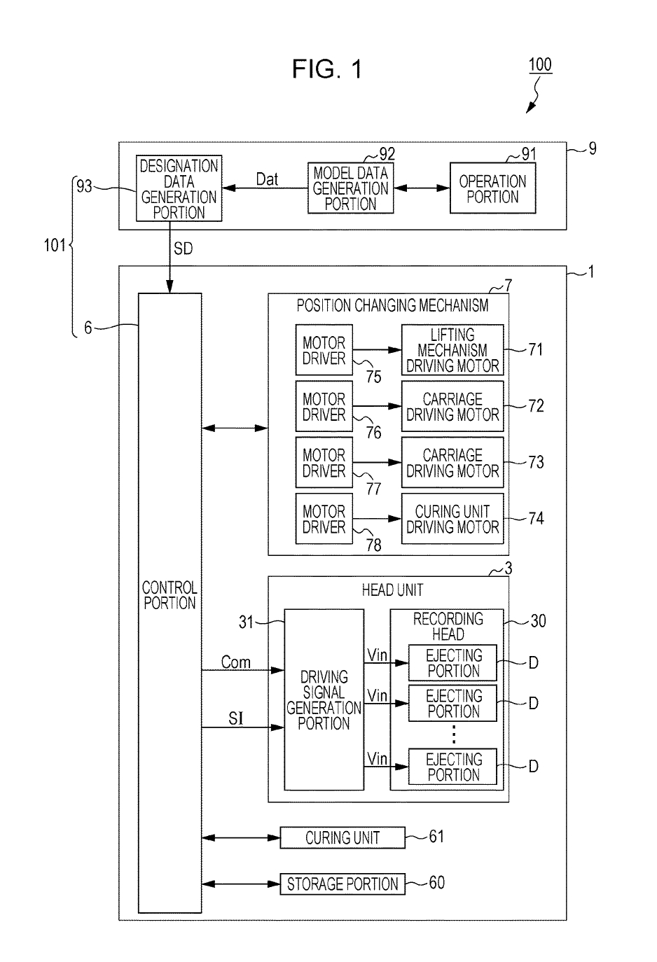

Hereinafter, with reference to FIGS. 1 to 9, a description will be made of a solid object shaping system 100 including a solid object shaping apparatus 1 according to the present embodiment.

FIG. 1 is a functional block diagram illustrating a configuration of the solid object shaping system 100.

As illustrated in FIG. 1, the solid object shaping system 100 includes the solid object shaping apparatus 1 and a host computer 9. The solid object shaping apparatus 1 performs a shaping process of ejecting ink, forming a layer-like shaping body LY (an example of a “shaping layer”) with a predetermined thickness ΔZ by using dots formed by the ejected ink, and shaping a solid object Obj by laminating the shaping body LY. The host computer 9 performs a data generation process of generating designation data SD designating a shape and a color of each of a plurality of shaping bodies LY constituting the solid object Obj shaped by the solid object shaping apparatus 1.

1.1 Host Computer

As illustrated in FIG. 1, the host computer 9 includes a CPU (not illustrated) which controls operations of respective portions of the host computer 9; a display portion (not illustrated) such as a display; an operation portion 91 such as a keyboard or a mouse; an information storage portion (not illustrated) which stores a control program for the host computer 9, a driver program for the solid object shaping apparatus 1, and application programs such as computer aided design (CAD) software; a model data generation portion 92 which generates model data Dat; and a designation data generation portion 93 which generates the data generation process of generating the designation data SD on the basis of the model data Dat.

Here, the model data Dat is data indicating a shape and a color of a model which represents the solid object Obj which is to be shaped by the solid object shaping apparatus 1, and designates a shape and a color of the solid object Obj. In the following description, it is assumed that a color of the solid object Obj includes a method of giving a plurality of colors in a case where the plurality of colors are given to the solid object Obj, that is, shapes, characters, and other images represented by the plurality of colors given to the solid object Obj.

The model data generation portion 92 is a functional block which is realized by the CPU of the host computer 9 executing the application programs stored in the information storage portion. The model data generation portion 92 is, for example, a CAD application, and generates the model data Dat indicating a model for representing a shape and a color of the solid object Obj on the basis of information or the like which is input by a user of the solid object shaping system 100 operating the operation portion 91.

In the present embodiment, it is assumed that the model data Dat designates an outer shape of the solid object Obj. In other words, it is assumed that the model data Dat designates a shape of a hollow object when the solid object Obj is assumed to be the hollow object, that is, a shape of an outer surface SF which is a contour of a model of the solid object Obj. For example, in a case where the solid object Obj is a sphere, the model data Dat designates a shape of a spherical surface which is a contour of the sphere.

However, the invention is not limited to such an aspect, and the model data Dat may include at least information which can specify a shape of an outer surface SF of a model of the solid object Obj. For example, the model data Dat may be data for designating a more inner shape than the outer surface SF of the model of the solid object Obj or a material of the solid object Obj in addition to a shape of the outer surface SF of the model of the solid object Obj and a color of the solid object Obj.

The model data Dat may have a data format such as Additive Manufacturing File Format (AMF) or Standard Triangulated Language (STL).

The designation data generation portion 93 is a functional block which is realized by the CPU of the host computer 9 executing the driver program for the solid object shaping apparatus 1 stored in the information storage portion. The designation data generation portion 93 performs the data generation process of generating the designation data SD for designating a shape and a color of the shaping body LY formed by the solid object shaping apparatus 1 on the basis of the model data Dat generated by the model data generation portion 92.

In the following description, it is assumed that the solid object Obj is shaped by laminating Q layer-like shaping bodies LY (where Q is a natural number which is equal to or greater than 2). A process in which the solid object shaping apparatus 1 forms the shaping body LY is referred to as a laminate process. In other words, the shaping process in which the solid object shaping apparatus 1 shapes the solid object Obj includes Q laminate processes. Hereinafter, the shaping body LY formed in the q-th laminate process among the Q laminate processes included in the shaping process is referred to as a shaping body LY[q], and the designation data SD for designating a shape and a color of the shaping body LY [q] is referred to as designation data SD[q] (where q is a natural number which is equal to or greater than 1 and is equal to or smaller than Q).

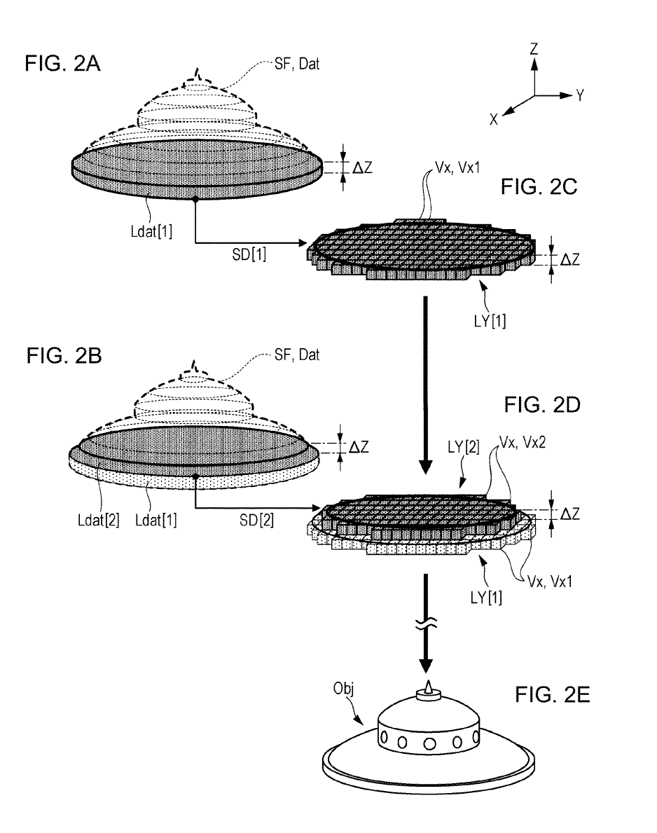

FIG. 2 is a diagram for explaining a relationship between the shape of an outer surface SF of a model of the solid object Obj designated by the model data Dat, and the shaping body LY formed by using the designation data SD.

As illustrated in FIGS. 2(A) and 2(B), in order to generate designation data SD[1] to SD[Q] designating shapes and colors of shaping bodies LY[1] to LY[Q] each having a predetermined thickness AZ, the designation data generation portion 93 first slices the outer surface SF of the model having a three-dimensional shape indicated by the model data Dat for each predetermined thickness AZ so as to generate sectional model data Ldat[1] to Ldat[Q] corresponding to the shaping bodies LY[1] to LY[Q] with a one-to-one relationship. Here, the section model data Ldat is data indicating a shape and a color of a sectional body obtained by slicing the model having a three-dimensional shape indicated by the model data Dat. However, the section model data Ldat may include data indicating a shape and a color of a section obtained by slicing the model having a three-dimensional shape indicated by the model data Dat. FIG. 2(A) exemplifies the section model data Ldat[1] corresponding to the shaping body LY[1] formed in the first laminate process, and FIG. 2(B) exemplifies the section model data Ldat[2] corresponding to the shaping body LY[2] formed in the second laminate process.

Next, in order to form the shaping body LY[q] corresponding to a shape and a color indicated by the section model data Ldat[q], the designation data generation portion 93 determines the arrangement of dots to be formed by the solid object shaping apparatus 1 and outputs a determination result as the designation data SD. More specifically, the designation data generation portion 93 generates shaping body data FD[q] on the basis of the section model data Ldat[q], and generates the designation data SD[q] on the basis of the shaping body data FD[q].

Here, the shaping body data FD[q] is data representing, as a set of voxels Vx, the shape and the color of the sectional body of the model of the solid object Obj indicated by the section model data Ldat[q], by subdividing the shape and the color of the sectional body of the model of the solid object Obj indicated by the section model data Ldat[q] in a lattice form.

The designation data SD[q] is data designating dots which are to be formed in each of a plurality of voxels Vx. In other words, the designation data SD is data designating a color and a size of a dot which is to be formed in order to shape the solid object Obj. For example, the designation data SD may designate a color of a dot depending on the type of ink used to form the dot. The type of ink will be described later.

The voxel Vx is a rectangular parallelepiped which has a predetermined size, a predetermined thickness AZ, and a predetermined volume. In the present specification, the rectangular parallelepiped will be described as a concept including a cube.

In the present embodiment, a volume and a size of the voxel Vx are determined in accordance with a size of a dot which can be formed by the solid object shaping apparatus 1. Hereinafter, a voxel Vx corresponding to the shaping body LY[q] is referred to as a voxel Vxq in some cases.

In addition, hereinafter, a constituent element of the shaping body LY constituting the solid object Obj is referred to as a block BL (an example of a “unit shaping body”), the constituent element being formed to correspond to a single voxel Vx and having a predetermined volume and a predetermined thickness AZ. As will be described later in detail, the block BL is constituted of one or a plurality of dots. In other words, the block BL is one or a plurality of dots which are formed to fill a single voxel Vx. In other words, in the present embodiment, the designation data SD designates that one or a plurality of dots are to be formed in each voxel Vx.

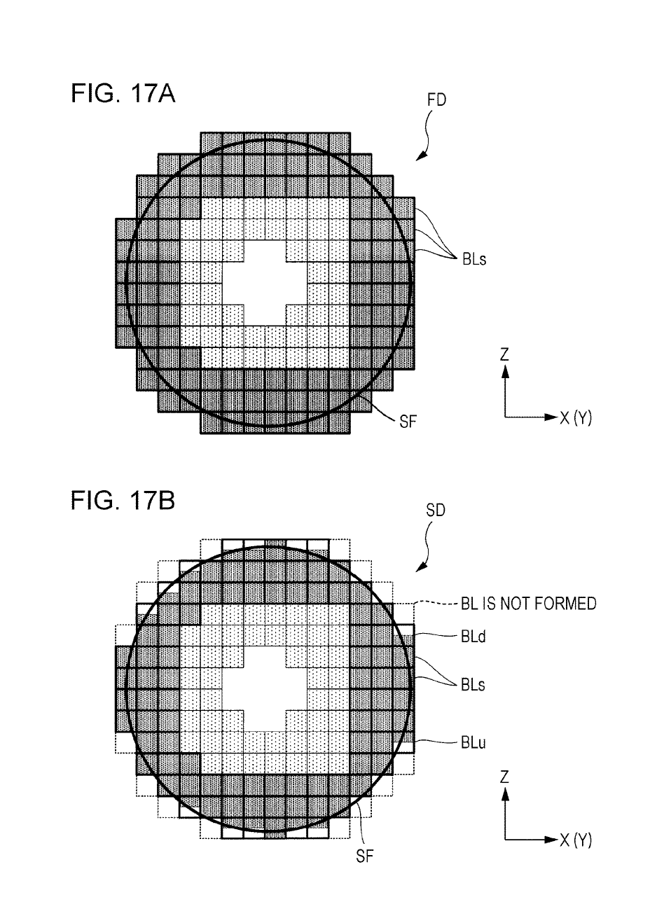

As described above, the solid object shaping system 100 shapes the solid object Obj as a set of the rectangular parallelepiped blocks BL by subdividing a model of the solid object Obj indicated by the model data Dat generated by the model data generation portion 92 in a lattice form. For this reason, precisely (speaking from the microscopic viewpoint), a shape of the solid object Obj is different from a shape of the model of the solid object Obj indicated by the model data Dat. In other words, the outer surface SF of the model of the solid object Obj indicated by the model data Dat is different from a shape of a surface of the solid object Obj which is actually shaped by the solid object shaping apparatus 1 (refer to FIGS. 17A and 17B which will be described later). For example, even if a shape of the outer surface SF of the model indicated by the model data Dat is a smooth curve, a surface of the solid object Obj shaped by the solid object shaping apparatus 1 may have an irregular shape from the microscopic viewpoint.

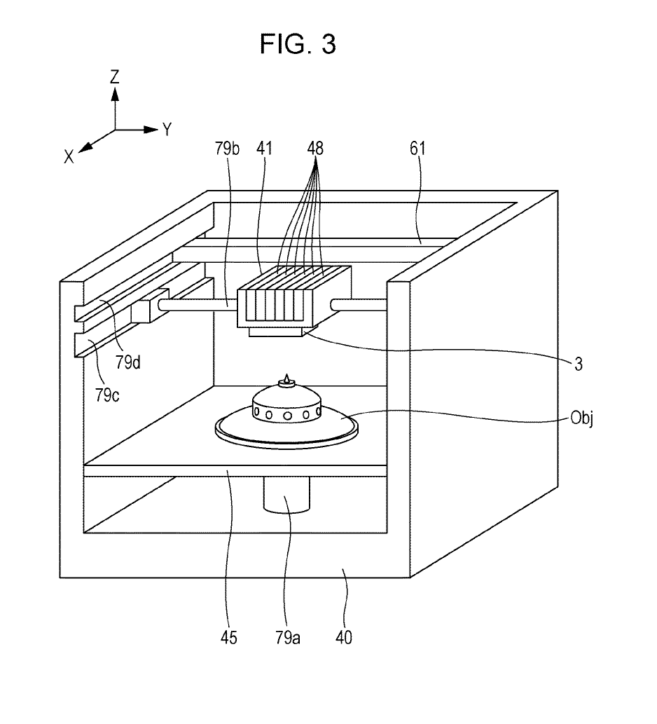

As illustrated in FIGS. 2(C) and 2(D), if the designation data SD[q] is supplied from the designation data generation portion 93, the solid object shaping apparatus 1 performs the laminate process of forming the shaping body LY[q]. FIG. 2(C) exemplifies a case where the first shaping body LY[1] is formed on a shaping platform 45 (refer to FIG. 3) on the basis of designation data SD[1] generated from the section model data Ldat [1], and FIG. 2(D) a case where the second shaping body LY[2] is formed on the first shaping body LY[1] on the basis of designation data SD[2] generated from the section model data Ldat[2].

The solid object shaping apparatus 1 sequentially laminates the shaping bodies LY[1] to LY[Q] corresponding to the designation data SD[1] to SD[Q], so as to shape the solid object Obj illustrated in FIG. 2(E).

As described above, the model data Dat according to the present embodiment designates a shape (a shape of a contour) of the outer surface SF of the model of the solid object Obj. For this reason, in a case where the solid object Obj having the shape indicated by the model data Dat is faithfully shaped, a shape of the solid object Obj is a hollow shape of only a contour without thickness. However, in a case where the solid object Obj is shaped, a more inner shape than the outer surface SF is preferably determined in consideration of the intensity or the like of the solid object Obj. Specifically, in a case where the solid object Obj is shaped, a part of a more inner region of the outer surface SF of the solid object Obj or the entire region preferably has a solid structure.

For this reason, as illustrated in FIG. 2, the designation data generation portion 93 according to the present embodiment generates the section model data Ldat which causes a part of a more inner region of the outer surface SF or the entire region to have a solid structure regardless of a shape designated by the model data Dat is a hollow shape.

Hereinafter, in the data generation process, a process of complementing a hollow portion of a shape of a model indicated by the model data Dat and generating the section model data Ldat which causes a shape of a part of or the entire hollow portion to have a solid structure, is referred to as a shape complementing process. The shape complementing process, and a more inner structure of the outer surface SF designated by the section model data Ldat will be described later in detail.

Meanwhile, in the example illustrated in FIG. 2, a voxel Vx1 constituting the shaping body LY[1] formed in the first laminate process is present under (−Z direction) a voxel Vx2 constituting the shaping body LY[2] formed in the second laminate process. However, the voxel Vx1 may not be present under the voxel Vx2 depending on a shape of the solid object Obj. In this case, even if a dot is formed in the voxel Vx2, there is a probability that the dot may fall to the lower side. Therefore, in a case where q is equal to or greater than 2, in order to form the voxel Vxq in which a dot constituting the shaping body LY[q] is to be inherently formed, a support for supporting the dot formed in the voxel Vxq is required to be provided at at least a part of the lower side of the voxel Vxq.

Therefore, in the present embodiment, the section model data Ldat includes data defining a shape of the support which is necessary during shaping of the solid object Obj in addition to the data regarding the solid object Obj. In other words, in the present embodiment, the shaping body LY[q] includes a portion of the solid object Obj which is to be formed in a q-th laminate process and a portion of the support which is to be formed in the q-th laminate process. In other words, the designation data SD[q] includes data which indicates a shape and a color of the portion of the solid object Obj formed as the shaping body LY[q], as a set of voxels Vxq, and data which indicates a shape of the portion of the support formed as the shaping body LY[q], as a set of voxels Vxq.

The designation data generation portion 93 according to the present embodiment determines whether or not the support is required to be provided in order to form the voxel Vxq on the basis of the model data Dat. If a result of the determination is affirmative, the designation data generation portion 93 generates the section model data Ldat which causes both the solid object Obj and the support to be provided.

The support is preferably made of a material which is easily removed after the solid object Obj is shaped, for example, water-soluble ink, or ink having a melting point lower than that of ink used to shape the solid object Obj.

1.2 Solid Object Shaping Apparatus

Next, the solid object shaping apparatus 1 will be described with reference to FIGS. 1 and 3. FIG. 3 is a perspective view illustrating a schematic structure of the solid object shaping apparatus 1.

As illustrated in FIGS. 1 and 3, the solid object shaping apparatus 1 includes a casing 40; a shaping platform 45; a control portion 6 (referred to as a “shaping control portion” in some cases) which controls an operation of each unit of the solid object shaping apparatus 1; a head unit 3 provided with a recording head 30 including an ejecting portion D which ejects ink toward the shaping platform 45; a curing unit 61 which cures the ink ejected on the shaping platform 45; six ink cartridges 48 which store ink; a carriage 41 in which the head unit 3 and the ink cartridges 48 are mounted; a position changing mechanism 7 which changes positions of the head unit 3, the shaping platform 45, and the curing unit 61 with respect to the casing 40; and a storage portion 60 which stores the control program for the solid object shaping apparatus 1 and other various information.

The control portion 6 and the designation data generation portion 93 function as a system controller 101 which controls an operation of each portion of the solid object shaping system 100.

The curing unit 61 is a constituent element which cures ink ejected on the shaping platform 45, and may be, for example, a light source which irradiates ultraviolet curable ink with ultraviolet rays, or a heater which heats resin ink. In a case where the curing unit 61 is an ultraviolet light source, the curing unit 61 may be provided, for example, over (+Z direction) of the shaping platform 45. On the other hand, in a case where the curing unit 61 is a superheater, for example, the curing unit 61 may be built into the shaping platform 45 or may be provided under the shaping platform 45. Hereinafter, a description will be made assuming that the curing unit 61 is an ultraviolet light source, and the curing unit 61 is located in the +Z direction of the shaping platform 45.

The six ink cartridges 48 are provided so as to correspond to a total of six types of ink including five color types of shaping ink for shaping the solid object Obj and support ink for forming a support with a one-to-one relationship. Each of the ink cartridges 48 stores the type of ink corresponding to the ink cartridge 48.

The five color types of shaping ink for shaping the solid object Obj include chromatic ink containing a chromatic colorant component, achromatic ink containing an achromatic colorant component, and clear (CL) ink in which the content of a colorant component per unit weight or per unit volume is smaller than that of the chromatic ink and the achromatic ink.

In the present embodiment, three color types of ink including cyan (CY) ink, magenta (MG) ink, and yellow (YL) ink are employed as the chromatic ink.

In the present embodiment, white (WT) ink is employed as the achromatic ink. The white ink according to the present embodiment is ink which reflects a predetermined proportion or higher of applied light in a case where the light having a wavelength included in a wavelength region (roughly, 400 nm to 700 nm) of visible light is applied to the white ink. The phrase “reflecting light of a predetermined proportion or higher” is the same meaning as “absorbing or transmitting light of below the predetermined proportion”, and corresponds to, for example, a case where a proportion of an amount of light reflected from the white ink to an amount of light applied to the white ink is equal to or higher than the predetermined proportion. In the present embodiment, the “predetermined proportion” may be, for example, any proportion of 30% or higher and 100% or lower, preferably any proportion of 50% or higher, and more preferably any proportion of 80% or higher.

In the present embodiment, the clear ink has the content of a colorant component lower than that of the chromatic ink and the achromatic ink and is thus highly transparent.

Hereinafter, among the five types of shaping ink, the three types of chromatic ink and the single type of achromatic ink are collectively referred to as coloring ink in some cases. The coloring ink is an example of a “first liquid”, and a color of the first liquid is an example of a “first color”. Clear ink whose content of colorant components is lower than that of the coloring ink is an example of a “second liquid”, and a color of the second liquid is an example of a “second color”.

In the present embodiment, each of the ink cartridges 48 is mounted in the carriage 41 but may be provided at other locations of the solid object shaping apparatus 1 instead of being mounted in the carriage 41.

As illustrated in FIGS. 1 and 3, the position changing mechanism 7 includes a lifting mechanism driving motor 71 for driving a shaping platform lifting mechanism 79a which moves up and down the shaping platform 45 in the +Z direction (hereinafter, the +Z direction is referred to as an “upper side” or an “upper direction” in some case) and the −Z direction (hereinafter, the −Z direction is referred to as a “lower side” or a “lower direction” in some case) (hereinafter, the +Z direction and the −Z direction are collectively referred to as a “Z axis direction” in some cases); a carriage driving motor 72 for moving the carriage 41 along a guide 79b in the +Y direction and the −Y direction (hereinafter, the +Y direction and the −Y direction are collectively referred to as a “Y axis direction” in some cases); a carriage driving motor 73 for moving the carriage 41 along a guide 79c in the +X direction and the −X direction (hereinafter, the +X direction and the −X direction are collectively referred to as a “X axis direction” in some cases); and a curing unit driving motor 74 for moving the curing unit 61 along a guide 79d in the +X direction and the −X direction.

The position changing mechanism 7 also includes a motor driver 75 which drives the lifting mechanism driving motor 71; a motor driver 76 which drives the carriage driving motor 72; a motor driver 77 which drives the carriage driving motor 73; and a motor driver 78 which drives the curing unit driving motor 74.

The storage portion 60 includes an electrically erasable programmable read-only memory (EEPROM) which is a kind of nonvolatile memory storing the designation data SD supplied from the host computer 9; a random access memory (RAM) which temporarily stores data required to perform various processes such as the shaping process of shaping the solid object Obj or in which the control program for controlling each portion of the solid object shaping apparatus 1 is temporarily developed in order to perform various processes such as the shaping process; and a PROM which is a kind of nonvolatile memory storing the control program.

The control portion 6 is configured to include a central processing unit (CPU) or a field-programmable gate array (FPGA), and controls an operation of each portion of the solid object shaping apparatus 1 when the CPU or the like operates according to the control program stored in the storage portion 60.

In a case where the designation data SD is supplied from the host computer 9, the control portion 6 controls operations of the head unit 3 and the position changing mechanism 7, and thus controls execution of the shaping process of shaping the solid object Obj corresponding to the model data Dat on the shaping platform 45.

Specifically, first, the control portion 6 stores the designation data SD supplied from the host computer 9 in the storage portion 60. Next, the control portion 6 controls an operation of the head unit 3 on the basis of various data such as the designation data SD stored in the storage portion 60, generates and outputs a driving waveform signal Com and a waveform designation signal SI for driving the ejecting portion D, and outputs the generated signals. The control portion 6 generates various signals for controlling operations of the motor drivers 75 to 78 on the basis of various data such as the designation data SD stored in the storage portion 60, and outputs the generated signals.

The driving waveform signal Com is an analog signal. For this reason, the control portion 6, which includes a DA conversion circuit (not illustrated), converts digital driving waveform signals generated by the CPU and the like included in the control portion 6 into analog driving waveform signals Com and outputs the converted signals.

As mentioned above, the control portion 6 controls a position of the head unit 3 relative to the shaping platform 45 via control of the motor drivers 75, 76 and 77, and controls a position of the curing unit 61 relative to the shaping platform 45 via control of the motor drivers 75 and 78. The control portion 6 controls whether or not ink is ejected from the ejecting portion D, an amount of ink to be ejected, ink ejection timing, and the like via control of the head unit 3.

Consequently, the control portion 6 controls execution of the laminate process in which dots are formed on the shaping platform 45 while adjusting sizes and arrangement of the dots formed by ink ejected on the shaping platform 45, and the shaping body LY is formed by curing the dots formed on the shaping platform 45. The control portion 6 controls execution of the shaping process in which new shaping bodies LY are laminated on the shaping body LY which has already been formed by repeatedly performing the laminate process, and thus the solid object Obj corresponding to the model data Dat is formed.

As illustrated in FIG. 1, the head unit 3 includes the recording head 30 provided with M ejecting portions D, and a driving signal generation portion 31 which generates a driving signal Vin for driving the ejecting portion D (where M is a natural number of 1 or greater). Hereinafter, in order to differentiate the M ejecting portions D provided in the recording head 30 from each other, ejecting portions D are sequentially referred to as a first stage ejecting portion D, a second stage ejecting portion D, . . . , and an M-th stage ejecting portion D in some cases. In addition, hereinafter, an m-th ejecting portion D of the M ejecting portions D provided in the recording head 30 is referred to as an ejecting portion D[m] in some cases (where m is a natural number which is equal to or greater than 1 and is equal to or smaller than M). Hereinafter, a driving signal Vin for driving the ejecting portion D[m] among the driving signals Vin generated by the driving signal generation portion 31 is referred to as a driving signal Vin[m] in some cases. Details of the driving signal generation portion 31 will be described later.

1.3 Recording Head

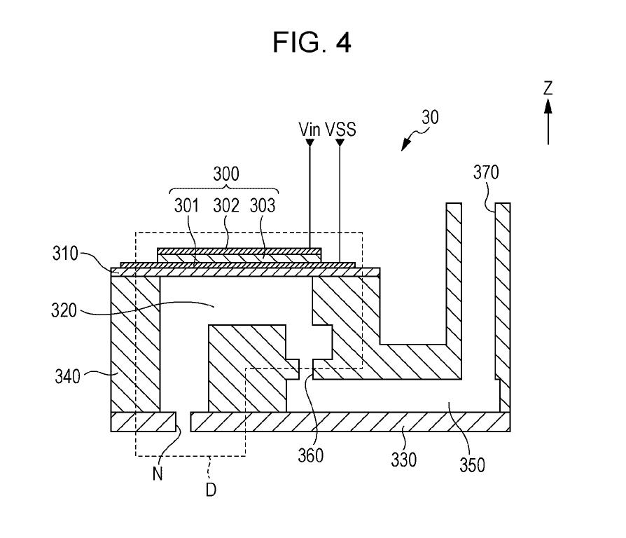

Next, with reference to FIGS. 4 to 6, a description will be made of the recording head 30 and the ejecting portion D provided in the recording head 30.

FIG. 4 illustrates an example of a schematic partial sectional view of the recording head 30. For convenience of illustration, in the recording head 30, FIG. 4 illustrates one ejecting portion D of the M ejecting portions D included in the recording head 30, a reservoir 350 which communicates with the one ejecting portion D via an ink supply port 360, and an ink intake port 370 for supplying ink from the ink cartridge 48 to the reservoir 350.

As illustrated in FIG. 4, the ejecting portion D includes a piezoelectric element 300, a cavity 320 filled with ink, a nozzle N which communicates with the cavity 320, and a vibration plate 310. In the ejecting portion D, the piezoelectric element 300 is driven by the driving signal Vin, and thus the ink in the cavity 320 is ejected from the nozzle N. The cavity 320 is a space partitioned by a cavity plate 340 which is molded in a predetermined shape having a recess, and a nozzle plate 330 in which the nozzle N is formed, and the vibration plate 310. The cavity 320 communicates with the reservoir 350 via the ink supply port 360. The reservoir 350 communicates with one ink cartridge 48 via the ink intake port 370.

In the present embodiment, as the piezoelectric element 300, for example, a unimorph (monomorph) type piezoelectric element as illustrated in FIG. 4 is used. The piezoelectric element 300 is not limited to the unimorph type piezoelectric element, and may be a piezoelectric element which can eject a liquid such as ink through deformation of the piezoelectric element 300, such as a bimorph type or laminate type piezoelectric element.

The piezoelectric element 300 includes a lower electrode 301, an upper electrode 302, and a piezoelectric body 303 provided between the lower electrode 301 and the upper electrode 302. If a potential of the lower electrode 301 is set to a predetermined reference potential VSS, and the driving signal Vin is supplied to the upper electrode 302 so that a voltage is applied between the lower electrode 301 and the upper electrode 302, the piezoelectric element 300 is bent (displaced) in a vertical direction in the figure according to the applied voltage, and thus the piezoelectric element 300 vibrates.

The vibration plate 310 is provided on an upper opening of the cavity plate 340, and the lower electrode 301 is joined to the vibration plate 310. For this reason, if the piezoelectric element 300 vibrates according to the driving signal Vin, the vibration plate 310 also vibrates. A volume of the cavity 320 (pressure in the cavity 320) is changed due to the vibration of the vibration plate 310, and thus the ink filling the cavity 320 is ejected from the nozzle N. If an amount of the ink in the cavity 320 is reduced due to the ejection of the ink, ink is supplied from the reservoir 350. In addition, ink is supplied to the reservoir 350 from the ink cartridge 48 via the ink intake port 370.

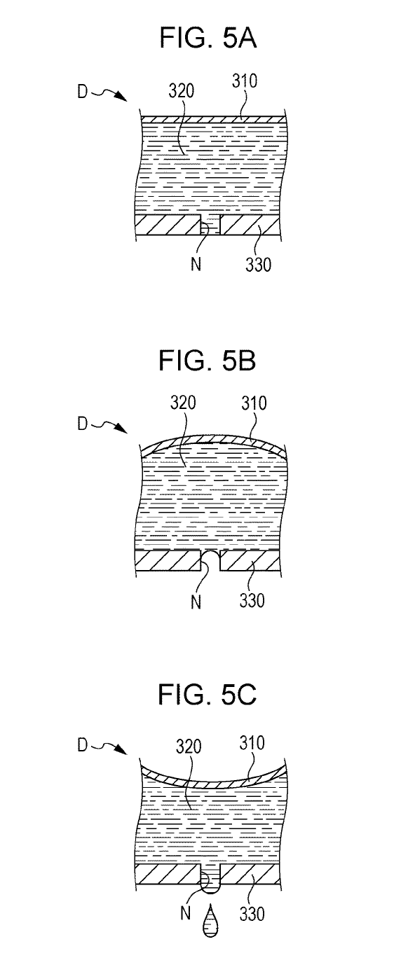

FIGS. 5A to 5C are diagrams for explaining an operation of ejecting ink from the ejecting portion D. In a state illustrated in FIG. 5A, if the driving signal Vin is supplied to the piezoelectric element 300 of the ejecting portion D from the driving signal generation portion 31, distortion corresponding to an electric field applied between the electrodes occurs in the piezoelectric element 300, and thus the vibration plate 310 of the ejecting portion D is bent upward in the figure. Consequently, the volume of the cavity 320 of the ejecting portion D increases as illustrated in FIG. 5B compared with the initial state illustrated in FIG. 5A. In a state illustrated in FIG. 5B, if a potential indicated by the driving signal Vin is changed, the vibration plate 310 is restored by an elastic restoring force thereof so as to be moved downward in the figure exceeding the position of the vibration plate 310 in the initial state, and thus the volume of the cavity 320 rapidly decreases as illustrated in FIG. 5C. At this time, some of the ink filling the cavity 320 is ejected as ink droplets from the nozzle N which communicates with the cavity 320 due to compression pressure occurring in the cavity 320.

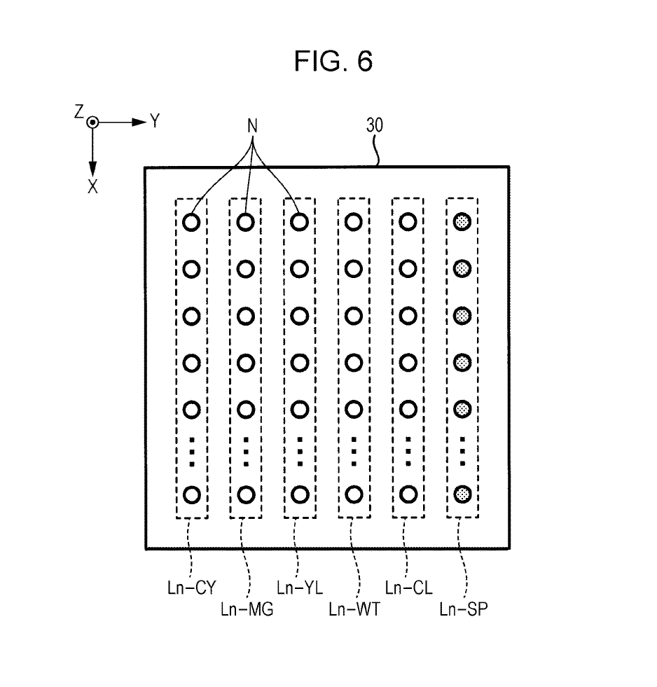

FIG. 6 is a diagram for explaining an example of arrangement of M nozzles N provided on the recording head 30 in a plan view of the solid object shaping apparatus 1 from the +Z direction or −Z direction.

As illustrated in FIG. 6, the recording head 30 is provided with six nozzle strings Ln including a nozzle string Ln-CY formed of a plurality of nozzles N, a nozzle string Ln-MG formed of a plurality of nozzles N, a nozzle string Ln-YL formed of a plurality of nozzles N, a nozzle string Ln-WT formed of a plurality of nozzles N, a nozzle string Ln-CL formed of a plurality of nozzles N, and a nozzle string Ln-SP formed of a plurality of nozzles N.

Here, the nozzles N included in the nozzle string Ln-CY are nozzles N provided in the ejecting portion D which ejects cyan (CY) ink; the nozzles N included in the nozzle string Ln-MG are nozzles N provided in the ejecting portion D which ejects magenta (MG) ink; the nozzles N included in the nozzle string Ln-YL are nozzles N provided in the ejecting portion D which ejects yellow (YL) ink; the nozzles N included in the nozzle string Ln-WT are nozzles N provided in the ejecting portion D which ejects white (WT) ink; the nozzles N included in the nozzle string Ln-CL are nozzles N provided in the ejecting portion D which ejects clear (CL) ink; and the nozzles N included in the nozzle string Ln-SP are nozzles N provided in the ejecting portion D which ejects support ink.

In the present embodiment, as illustrated in FIG. 6, a case is exemplified in which the plurality of nozzles N included in each nozzle string Ln are disposed to be arranged in a column in the X axis direction. However, for example, some (for example, even-numbered nozzles N) of the plurality of nozzles N included in each nozzle string Ln and the other nozzles N (for example, odd-numbered nozzles N) may be different from each other in positions in the Y axis direction, that is, may be disposed in a so-called zigzag shape. In each nozzle string Ln, an interval (pitch) between the nozzles N may be set as appropriate according to printing resolution (dot per inch: dpi).

1.4 Driving Signal Generation Portion

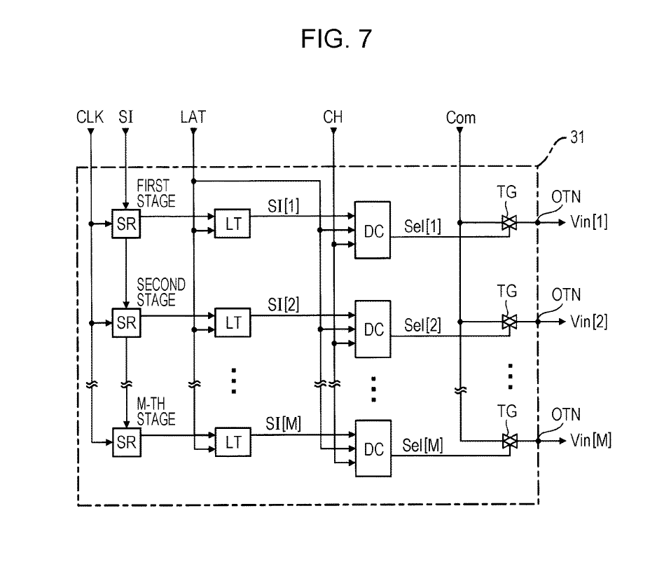

Next, with reference to FIGS. 7 to 9, a description will be made of a configuration and an operation of the driving signal generation portion 31.

FIG. 7 is a block diagram illustrating a configuration of the driving signal generation portion 31.

As illustrated in FIG. 7, the driving signal generation portion 31 is provided with M sets each of which includes a shift register SR, a latch circuit LT, a decoder DC, and a transmission gate TG, so as to respectively correspond to the M ejecting portions D provided in the recording head 30. Hereinafter, the respective elements constituting in the M sets included in the driving signal generation portion 31 and the recording head 30 are sequentially referred to as first stage elements, second stage elements, . . . , and M-th stage elements from the top in the figure.

A clock signal CLK, a waveform designation signal SI, a latch signal LAT, a change signal CH, and a driving waveform signal Com are supplied to the control portion 6 from the driving signal generation portion 31.

The waveform designation signal SI is a digital signal which is defined on the basis of the designation data SD and designates whether or not ink is to be ejected from the ejecting portion D and an amount of ink to be ejected from the ejecting portion D, and includes waveform designation signals SI[1] to SI[M]. Among the signals, the waveform designation signal SI[m] defines whether or not ink is to be ejected from the ejecting portion D[m], and an amount of ink to be ejected, in two bits including a high-order bit b1 and a low-order bit b2. Specifically, the waveform designation signal SI[m] designates any one of ejection of ink in an amount corresponding to a large dot, ejection of ink in an amount corresponding to a medium dot, ejection of ink in an amount corresponding to a small dot, and non-ejection of ink, for the ejecting portion D[m].

Each of the shift registers SR temporarily holds a 2-bit waveform designation signal SI[m] corresponding to each stage among the waveform designation signals SI (SI[1] to SI[M]). Specifically, the M shift registers SR including the first, second, . . . and M-th stage shift registers SR which respectively correspond to the M ejecting portions D[1] to D[M] are connected to each other in the vertical direction. In addition, the waveform designation signals SI which are serially supplied are transmitted to the subsequent stages according to the clock signal CLK. In a case where the waveform designation signals SI have been transmitted to all of the M shift registers SR, each of the M shift registers SR holds the 2-bit waveform designation signal SI[m] corresponding thereto among the waveform designation signals SI.

The M latch circuits LT simultaneously latch the 2-bit waveform designation signal SI[m], corresponding to the respective stages, held in the M shift registers SR, at a rising timing of the latch signal LAT.

Meanwhile, an operation period which is a period in which the solid object shaping apparatus 1 performs the shaping process includes a plurality of unit periods Tu. In the present embodiment, each of the unit periods Tu is formed of two control periods Ts (Ts1 and Ts2). In the present embodiment, the two control periods Ts1 and Ts2 have the same duration. As will be described later in detail, the unit period Tu is defined by the latch signal LAT, and the control period Ts is defined by the latch signal LAT and the change signal CH.

The control portion 6 supplies the waveform designation signal SI to the driving signal generation portion 31 at a timing before the unit period Tu starts. The control portion 6 supplies the latch signal LAT to each latch circuit LT of the driving signal generation portion 31 so that the waveform designation signal SI[m] is latched for each unit period Tu.

The m-th stage decoder DC decodes the 2-bit waveform designation signal SI[m] latched by the m-th latch circuit LT, and outputs a selection signal Sel[m] which is set to either a high level (“H” level) or a low level (“L” level) in each of the control periods Ts1 and Ts2.

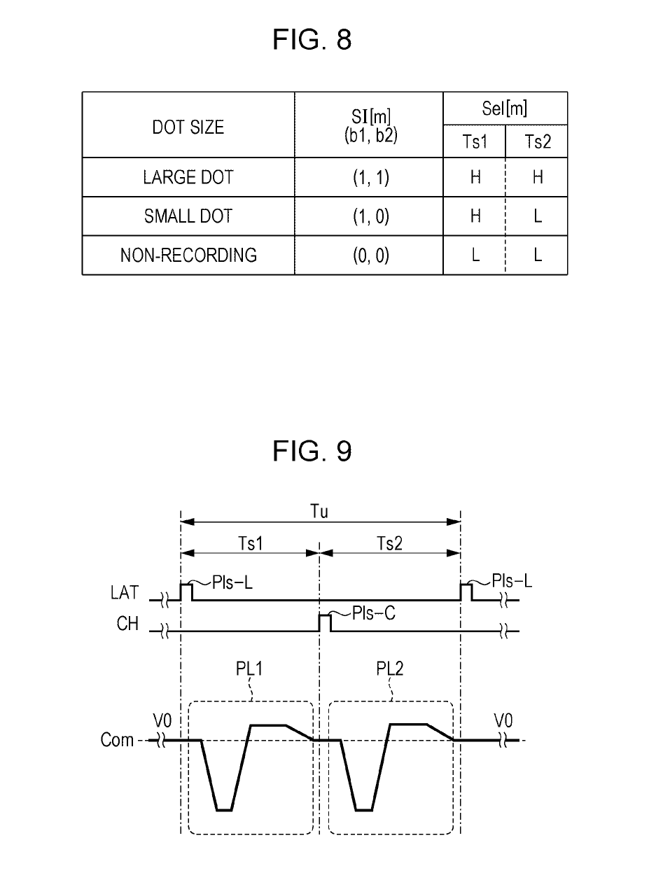

FIG. 8 is a diagram for explaining the content decoded by the decoder DC. As illustrated in FIG. 8, the m-th stage decoder DC sets the selection signal Sel[m] to an “H” level in the control periods Ts1 and Ts2 if the content indicated by the waveform designation signal SI[m] is (b1, b2)=(1, 1). The m-th stage decoder DC sets the selection signal Sel[m] to an “H” level in the control period Ts1 and sets the selection signal Sel[m] to an “L” level in the control period Ts2 if the content indicated by the waveform designation signal SI[m] is (b1, b2)=(1, 0). The m-th stage decoder DC sets the selection signal Sel[m] to an “L” level in the control periods Ts1 and Ts2 if the content indicated by the waveform designation signal SI[m] is (b1, b2)=(0, 0).

As illustrated in FIG. 7, the M transmission gates TG included in the driving signal generation portion 31 are provided so as to respectively correspond to the M ejecting portions D of the recording head 30. The m-th stage transmission gate TG is turned on when the selection signal Sel[m] output from the m-th stage decoder DC is in an “H” level, and is turned off when the selection signal Sel[m] is in an “L” level. The driving waveform. signal Com is supplied to one end of each transmission gate TG. The other end of the m-th stage transmission gate TG is electrically connected to an m-th stage output end OTN.

If the selection signal Sel[m] is brought into an “H” level, and thus the m-th stage transmission gate TG is turned on, the driving waveform signal Com is supplied from the m-th stage output end OTN to the ejecting portion D[m] as the driving signal Vin[m].

As will be described later in detail, in the present embodiment, a potential of the driving waveform signal Com is set to a reference potential VO at timings (that is, start and end timings of the control periods Ts) at which the transmission gate TG is switched from an ON state to an OFF state. For this reason, in a case where the transmission gate TG is turned off, a potential of the output end OTN is maintained in the reference potential VO due to the capacity of the piezoelectric element 300 of the ejecting portion D[m]. Hereinafter, for convenience of description, the description will be made assuming that, if the transmission gate TG is turned off, a potential of the driving signal Vin[m] is maintained as the reference potential V0.

As described above, the control portion 6 controls the driving signal generation portion 31 so that the driving signal Vin is supplied to each ejecting portion D for each unit period Tu. Consequently, each ejecting portion D can eject ink in an amount corresponding to a value indicated by the waveform designation signal SI which is defined on the basis of the waveform designation signal SI, and can thus form dots on the shaping platform 45.

FIG. 9 is a timing chart for explaining various signals which are supplied from the control portion 6 to the driving signal generation portion 31 in each unit period Tu.

As exemplified in FIG. 9, the latch signal LAT includes a pulse waveform Pls-L, and the unit period Tu is defined by the pulse waveform Pls-L. The change signal CH includes a pulse waveform Pls-C, and the unit period Tu is divided into the control periods Ts1 and Ts2 by the pulse waveform Pls-C. Although not illustrated, the control portion 6 serially supplies the waveform designation signal SI to the driving signal generation portion 31 in synchronization with the clock signal CLK for each unit period Tu.

As exemplified in FIG. 9, the driving waveform signal Com includes a waveform PL1 disposed in the control period Ts1, and a waveform PL2 disposed in the control period Ts2. Hereinafter, the waveforms PL1 and PL2 are collectively referred to as a waveform PL in some cases. In the present embodiment, a potential of the driving waveform signal Com is set to the reference potential VO at the start or end timing of each control period Ts.

In a case where the selection signal Sel[m] is in an “H” level in a certain control period Ts, the driving signal generation portion 31 supplies the waveform PL of the driving waveform signal Com disposed in the control period Ts to the ejecting portion D[m] as the driving signal Vin[m]. Conversely, in a case where the selection signal Sel[m] is in an “L” level in a certain control period Ts, the driving signal generation portion 31 supplies the waveform PL of the driving waveform signal Com set to the reference potential V0 to the ejecting portion D[m] as the driving signal Vin[m].

Therefore, the driving signal Vin[m] supplied to the ejecting portion D[m] in the unit period Tu by the driving signal generation portion 31 becomes a signal having the waveforms PL1 and PL2 if a value indicated by the waveform designation signal SI[m] is (b1, b2)=(1, 1). The driving signal Vin[m] becomes a signal having the waveform PL1 if a value indicated by the waveform designation signal SI[m] is (b1, b2)=(1, 0). The driving signal Vin[m] becomes a signal set to the reference potential V0 if a value indicated by the waveform designation signal SI[m] is (b1, b2)=(0, 0).

If the driving signal Vin[m] having a single waveform PL is supplied, the ejecting portion D[m] ejects about a small amount of ink so as to form a small dot.

For this reason, in a case where a value indicated by the waveform designation signal SI[m] is (b1, b2)=(0, 1) and the driving signal Vin[m] supplied to the ejecting portion D[m] has a single waveform PL (PL1) in the unit period Tu, about a small amount of ink is ejected from the ejecting portion D[m] on the basis of the single waveform PL, and thus a small dot is formed by the ejected ink.

In a case where a value indicated by the waveform designation signal SI[m] is (b1, b2)=(1, 1) and the driving signal Vin[m] supplied to the ejecting portion D[m] has two waveforms PL (PL1 and PL2) in the unit period Tu, about a small amount of ink is ejected from the ejecting portion D[m] twice on the basis of the two waveforms PL, and a large dot is formed through combination of about a small amount of ink ejected twice.

On the other hand, in a case where a value indicated by the waveform designation signal SI[m] is (b1, b2)=(0, 0) and the driving signal Vin[m] supplied to the ejecting portion D[m] is maintained in the reference potential V0 without the waveform PL in the unit period Tu, ink is not ejected from the ejecting portion D[m], and thus no dot is formed (recording is not performed).

In the present embodiment, as is clear from the above description, a case is assumed that a large dot has a double size of a small dot.

In the present embodiment, the waveform PL of the driving waveform signal Com is defined so that about a small amount of ink ejected for forming a small dot is substantially a half of an amount of ink which is necessary in order to form a block BL. In other words, the block BL is formed of either one of two patterns including a single large dot and two small dots.

In the present embodiment, a single block BL is provided in a single voxel Vx. That is, in the present embodiment, dots are formed in a single voxel Vx in either one of two patterns including a single large dot and two small dots.

2. Data Generation Process and Shaping Process

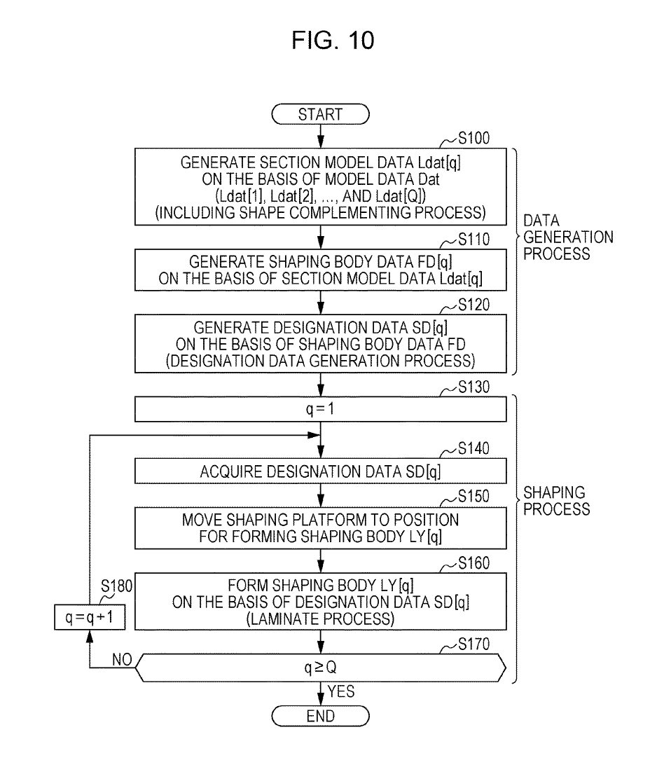

Next, with reference to FIGS. 10 to 17B, a description will be made of the data generation process and the shaping process performed by the solid object shaping system 100.

2.1 Summary of Data Generation Process and Shaping Process

FIG. 10 is a flowchart illustrating an example of an operation of the solid object shaping system 100 in a case where the data generation process and the shaping process are performed.

The data generation process is a process performed by the designation data generation portion 93 of the host computer 9, and is started when the designation data generation portion 93 acquires the model data Dat output from the model data generation portion 92. Processes in steps S100, S110 and S120 illustrated in FIG. 10 correspond to the data generation process.

As illustrated in FIG. 10, if the data generation process is started, the designation data generation portion 93 generates the section model data Ldat[q] (Ldat[1] to Ldat[Q]) on the basis of the model data Dat output from the model data generation portion 92 (S100). As described above, in step S100, the designation data generation portion 93 performs the shape complementing process of complementing a hollow portion of a shape indicated by the model data Dat is complemented, and generating the section model data Ldat which causes a part of a more inner region of an outer surface SF of a model of the solid object Obj indicated by the model data Dat or the entire region to have a solid shape. Details of the shape complementing process will be described later.

Next, the designation data generation portion 93 generates discrete shaping body data FD[q] by sorting shapes and colors indicated by the section model data Ldat[q] in the unit of the voxel Vx (S110). In the present embodiment, a case is assumed in which a set of voxels Vx indicated by the shaping body data FD is provided to include the model indicated by the model data Dat (refer to FIG. 17A).

Next, the designation data generation portion 93 performs a designation data generation process of determining a block BL (that is, arrangement of dots to be formed by the solid object shaping apparatus 1) to be formed by the solid object shaping apparatus 1 in order to form the shaping body LY[q] on the basis of the shaping body data FD and the model data Dat, and generating the designation data SD[q] on the basis of a determination result (S120). Specifically, the designation data generation portion 93 generates the designation data SD by determining tones of a color representing the block BL to be formed in each voxel Vx in the designation data generation process in step S120. Details of the designation data generation process and the type of block BL to be determined in the designation data generation process will be described later.

As mentioned above, the designation data generation portion 93 performs the data generation process indicated by steps S100 to S120 of FIG. 10.

The solid object shaping system 100 performs the data generation process and then performs the shaping process.

The shaping process is a process performed by the solid object shaping apparatus 1 under the control of the control portion 6, and is started when the designation data SD output from the host computer 9 is acquired by the solid object shaping apparatus 1 and is stored in the storage portion 60. Processes in steps S130 to S180 illustrated in FIG. 10 correspond to the shaping process.

As illustrated in FIG. 10, the control portion 6 sets a variable q indicating the number of laminate processes to be performed to “1” (S130). Next, the control portion 6 acquires the designation data SD[q] generated by the designation data generation portion 93 from the storage portion 60 (S140). The control portion 6 controls the lifting mechanism driving motor 71 so that the shaping platform 45 is moved to a position for forming the shaping body LY[q] (S150).

The position of the shaping platform 45 for forming the shaping body LY[q] may be any position as long as ink ejected from the head unit 3 can be landed at the position with respect to a dot formation location (voxel Vxq) indicated by the designation data SD[q]. For example, in step S150, the control portion 6 may control a position of the shaping platform 45 so that a gap between the shaping body LY[q] and the head unit 3 in the Z axis direction is made constant. In this case, the control portion 6 may form the shaping body LY[q] in the q-th laminate process, and then may move the shaping platform 45 by the predetermined thickness AZ in the −Z direction until a shaping body LY[q+1] starts to be formed through a (q+1)-th laminate process.

Next, the control portion 6 controls operations of the head unit 3, the position changing mechanism 7, and the curing unit 61 (hereinafter, referred to as the “head unit 3 and the like”) so that the shaping body LY[q] corresponding to the designation data SD[q] is formed (S160). As is clear from FIG. 2, the shaping body LY[1] is formed on the shaping platform 45, and the shaping body LY[q+1] is formed on the shaping body LY[q].

Thereafter, the control portion 6 determines whether or not q is equal to or greater than Q (S170), and determines that shaping of the solid object Obj is completed and finishes the shaping process if a determination result is affirmative. On the other hand, if a determination result is negative, 1 is added to the variable q, and the process proceeds to step S140 (S180).

As mentioned above, the designation data generation portion 93 of the solid object shaping system 100 performs the data generation process indicated by steps S100 to S120 of FIG. 10, and thus the designation data SD[1] to SD[Q] is generated on the basis of the model data Dat. The solid object shaping apparatus 1 of the solid object shaping system 100 performs the shaping process indicated by steps S130 to S180 of FIG. 10 under the control of the control portion 6, and thus such a solid object Obj which reproduces a shape and a color of a model indicated by the model data Dat is shaped.

FIG. 10 illustrates only an example of a flow of the data generation process and the shaping process. For example, in FIG. 10, the data generation process is completed and then the shaping process is started, but the invention is not limited to such an aspect, and the shaping process may be started before the data generation process is completed. For example, in a case where the designation data SD[q] is generated in the data generation process, a shaping process (that is, the q-th laminate process) of forming the shaping body LY[q] may be performed after the designation data SD[q] is acquired without waiting for the next designation data SD[q+1] to be generated.

2.2 Shape Complementing Process

As described above, in step S100, the designation data generation portion 93 performs the shape complementing process of complementing a part of or the hollow portion of a shape of the outer surface SF of the model of the solid object Obj designated by the model data Dat and generating the section model data Ldat which causes a part of a more inner region of the outer surface SF of a model of the solid object Obj or the entire region to have a solid structure.

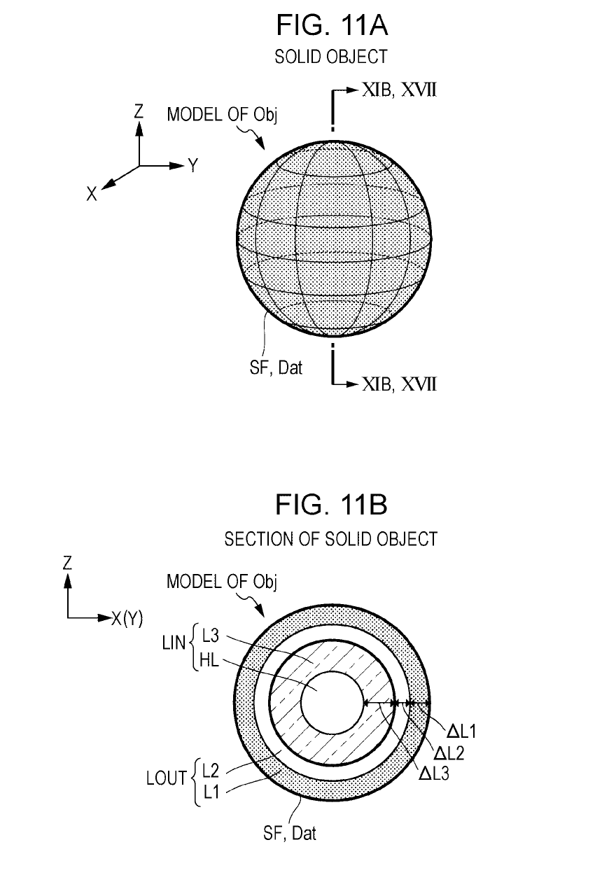

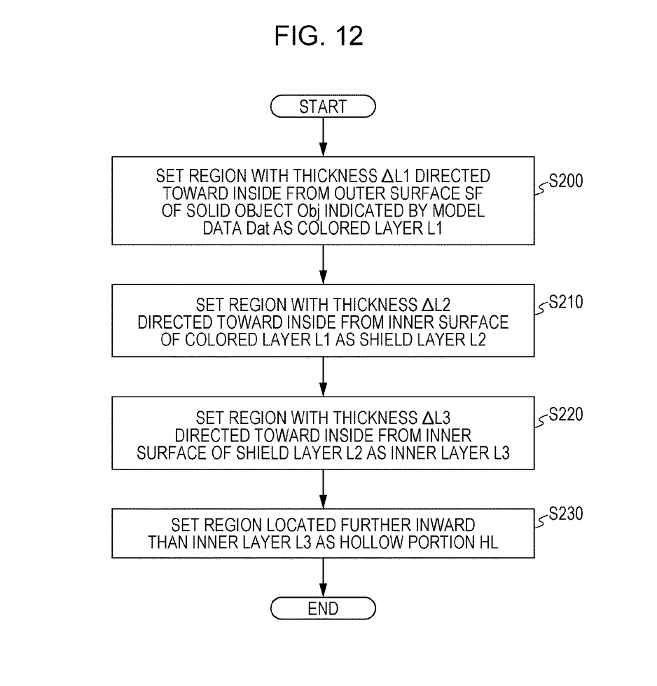

Hereinafter, with reference to FIGS. 11A to 12, a description will be made of a more inner structure of the outer surface SF of the model of the solid object Obj indicated by the section model data Ldat and the shape complementing process of defining the more inner structure of the outer surface SF.

First, with reference to FIGS. 11A and 11B, a description will be made of a more inner structure of the outer surface SF of the model of the solid object Obj indicated by the section model data Ldat.

Here, FIG. 11A is a perspective view of the model of the solid object Obj indicated by the section model data Ldat, and FIG. 11B is a sectional view obtained when cutting the model of the solid object Obj illustrated in FIG. 11A on a plane parallel to the X axis and the Y axis along a straight line γ-Γ. In FIGS. 11A and 11B, for convenience of illustration, a case is assumed in which a spherical solid object Obj having a shape which is different from that in FIGS. 2 and 3.

As illustrated in FIG. 11B, the solid object Obj shaped on the basis of the section model data Ldat includes three layers such as a colored layer L1, a shield layer L2, and an inner layer L3, and a hollow portion HL which is located further inward than the three layers, in this order toward the inside of the solid object Obj from a surface of the solid object Obj.

Here, the colored layer L1 is a layer which is formed by ink containing shaping ink, and is a layer including the surface of the solid object Obj for representing a color of the solid object Obj. The shield layer L2 is a layer which is formed by using, for example, white ink, and is a layer for preventing a color of a more inner portion of the colored layer L1 in the solid object Obj from being transmitted through the colored layer L1 and being thus visually recognized from the outside of the solid object Obj. In other words, the colored layer L1 and the shield layer L2 are provided so that a color to be displayed by the solid object Obj is accurately represented. Hereinafter, in the solid object Obj, the colored layer L1 and the shield layer L2, which are provided so that a color to be displayed by the solid object Obj is accurately represented, are referred to as an outer region LOUT of the solid object Obj in some cases.

The inner layer L3 is a layer which is provided to ensure the intensity of the solid object Obj, and is formed by using clear ink as a principle. Hereinafter, in the solid object Obj, the inner layer L3 and the hollow portion HL provided further inward than the outer region LOUT are referred to as an inner region LIN (or the “inside of the solid object Obj”) of the solid object Obj in some cases.

In the present embodiment, for simplification, as illustrated in FIG. 11B, a case is assumed that the colored layer L1 has a substantially uniform thickness ΔL1, the shield layer L2 has a substantially uniform thickness ΔL2, and the inner layer L3 has a substantially uniform thickness ΔL3, but a thickness of each layer may not be substantially uniform.

In the present specification, the expression such as “substantially uniform” or “substantially the same” includes not only a case of being completely uniform or the same but also a case of being regarded to be uniform or the same if various errors are ignored. The various errors which can be ignored are assumed to include discrete errors occurring when a shape indicated by the model data Dat is represented as a set of voxels Vx.

FIG. 12 is a flowchart illustrating an example of an operation of the designation data generation portion 93 in a case of performing the shape complementing process.

As illustrated in FIG. 12, first, the designation data generation portion 93 sets a region with the thickness AL1 which is directed from the outer surface SF of the model of the solid object Obj toward the inside of the model of the solid object Obj as the colored layer L1 in the model of the solid object Obj indicated by the model data Dat (S200). The designation data generation portion 93 sets a region with the thickness ΔL2 which is directed from an inner surface of the colored layer L1 toward the inside of the model of the solid object Obj as the shield layer L2 (S210). The designation data generation portion 93 sets a region with the thickness ΔL3 which is directed from an inner surface of the shield layer L2 toward the inside of the model of the solid object Obj as the inner layer L3 (S220). The designation data generation portion 93 sets a portion of the model of the solid object Obj located further inward than the inner layer L3 as the hollow portion HL (S230).

The designation data generation portion 93 performs the above-described shape complementing process so as to generate the section model data Ldat for shaping the solid object Obj having the colored layer L1, the shield layer L2, and the inner layer L3 as exemplified in FIG. 11B.

2.3 Designation Data Generation Process

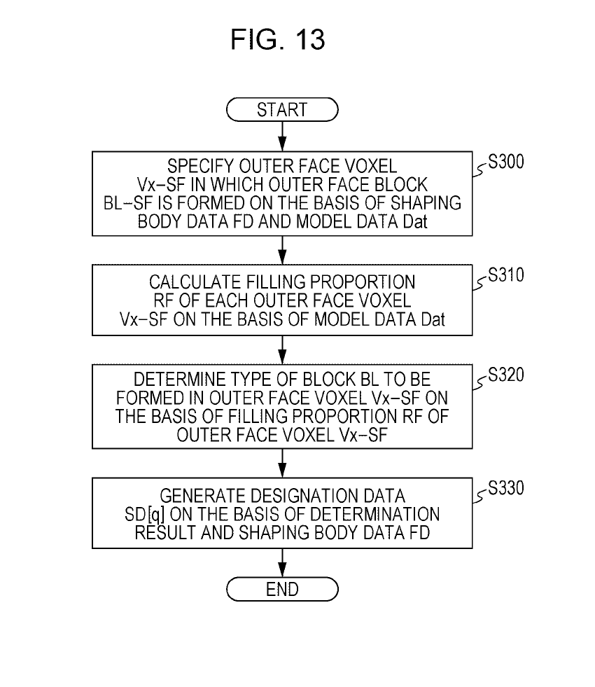

In step S120, the designation data generation portion 93 performs the designation data generation process of determining the type of block BL to be formed in each voxel Vx on the basis of the shaping body data FD and the model data Dat and generating the designation data SD on the basis of the determination result and the shaping body data FD. Hereinafter, the designation data generation process will be described with reference to FIGS. 13 to 17B.

FIG. 13 is a flowchart illustrating an example of an operation of the designation data generation portion 93 in a case of performing the designation data generation process. Hereinafter, a description will be made of summary of the designation data generation process with reference to FIG. 13.

As illustrated in FIG. 13, first, the designation data generation portion 93 specifies an outer face voxel Vx-SF from a set of voxels Vx obtained as a result of discretizing a model of the solid object Obj on the basis of the shaping body data FD and the model data Dat (S300).

Here, the outer face voxel Vx-SF is a voxel Vx which is present at a location including the inside and the outside of the outer surface SF of the model when the model indicated by the model data Dat is discretized as a set of voxels Vx. In other words, the outer face voxel Vx-SF is a voxel Vx including the outer surface SF of the model of the solid object Obj, that is, a voxel Vx located at a contour portion of the model. Hereinafter, a block BL formed in the outer face voxel Vx-SF is referred to as an outer face block BL-SF. The outer face block BL-SF includes the inside and the outside of the outer surface SF of the model in a case of assuming that the model indicated by the model data Dat and the solid object Obj are disposed at the same position.

The process in step S300 performed by the designation data generation portion 93 may be any process as long as the outer face block BL-SF can be specified from a set of blocks BL constituting the solid object Obj through the process.

Next, the designation data generation portion 93 calculates a filling proportion RF which is a proportion of a volume occupied by a more inner portion of the outer surface SF of the model indicated by the model data Dat to a total volume of the outer face voxel Vx-SF in the outer face voxel Vx-SF (S310). As will be described later in detail, in the present embodiment, the filling proportion RF collectively refers to an upper side filling proportion RFu, a lower side filling proportion RFd, and a whole filling proportion RF-all.

Next, the designation data generation portion 93 determines the type of block BL to be formed in the outer face voxel Vx-SF on the basis of the filling proportion RF of each outer face voxel Vx-SF (S320). As will be described later in detail, in the present embodiment, the solid object shaping system 100 can form at least three types of blocks BL including a single-color block BLs (an example of a “first unit shaping body”), a lower side colored block BLd (an example of a “second unit shaping body”), and an upper side colored block BLu (an example of a “third unit shaping body”). In other words, in step S320, the designation data generation portion 93 selects a block BL to be formed in the outer face voxel Vx-SF among at least three types of blocks including the single-color block BLs, the lower side colored block BLd, and the upper side colored block BLu.

Next, the designation data generation portion 93 generates the designation data SD on the basis of the determination result (selection result) in step S320 and the shaping body data FD (S330).

Hereinafter, a description will be made of the three types of blocks BL which can be selected by the designation data generation portion 93 in step S320.

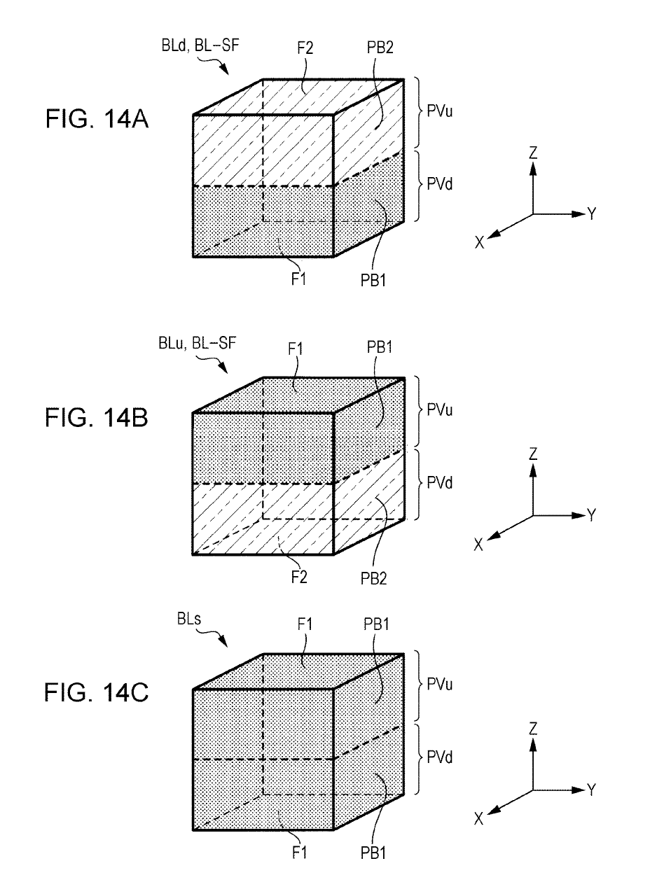

FIGS. 14A to 14C are diagrams illustrating three types of blocks BL which can be formed as an outer face block BL-SF in an outer face voxel Vx-SF by the solid object shaping system 100.

Among the blocks, a lower side colored block BLd illustrated in FIG. 14A is an outer face block BL-SF which includes a colored portion PB1 and a colorless portion PB2. The colored portion PB1 is formed of dots which are formed in a voxel lower portion PVd by using a coloring ink having a color which is designated for a voxel Vx by the shaping body data FD, and the colorless portion PB2 is formed of dots which are formed in a voxel upper portion PVu by using clear ink. The voxel upper portion PVu is a lower portion of a voxel Vx located further upward than a virtual plane when the voxel Vx is equally divided into two portions by the virtual plane perpendicular to the Z axis direction, and the voxel lower portion PVd is a lower portion of the voxel Vx located further downward than the virtual plane.

An upper side colored block BLu illustrated in FIG. 14B is an outer face block BL-SF which includes the colorless portion PB2 and the colored portion PB1. The colorless portion PB2 is formed of dots which are formed in the voxel lower portion PVd by using clear ink. The colored portion PB1 is formed of dots which are formed in the voxel upper portion PVu by using a coloring ink having a color which is designated for a voxel Vx by the shaping body data FD.

Hereinafter, the lower side colored block BLd and the upper side colored block BLu are collectively referred to as a separate block BLb in some cases.

A single-color block BLs illustrated in FIG. 14C is a block BL formed by using a coloring ink having a color which is designated for a voxel Vx by the shaping body data FD. In other words, the single-color block BLs is a block in which both of the voxel lower portion PVd and the voxel upper portion PVu are the colored portion PB1.

Hereinafter, among six faces of a rectangular parallelepiped shape of the separate block BLb, of two faces (that is, an upper face and a lower face of the separate block BLb) perpendicular to the Z axis, a face included in the colored portion PB1 is referred to as a colored face F1 (an example of a “first face”), and a face included in the colorless portion PB2 is referred to as a colorless face F2 (an example of a “second face”). Specifically, in the lower side colored block BLd illustrated in FIG. 14A, the upper face is the colorless face F2, and the lower face is the colored face F1. In the upper side colored block BLu illustrated in FIG. 14B, the upper face is the colored face F1, and the lower face is the colorless face F2.

A voxel Vx in which the separate block BLb is formed is limited to the outer face voxel Vx-SF, but a voxel Vx in which the single-color block BLs is formed is not limited to the outer face voxel Vx-SF. In the present embodiment, among a plurality of blocks BL constituting the colored layer L1, blocks BL other than the separate block BLb are assumed to be the single-color blocks BLs.

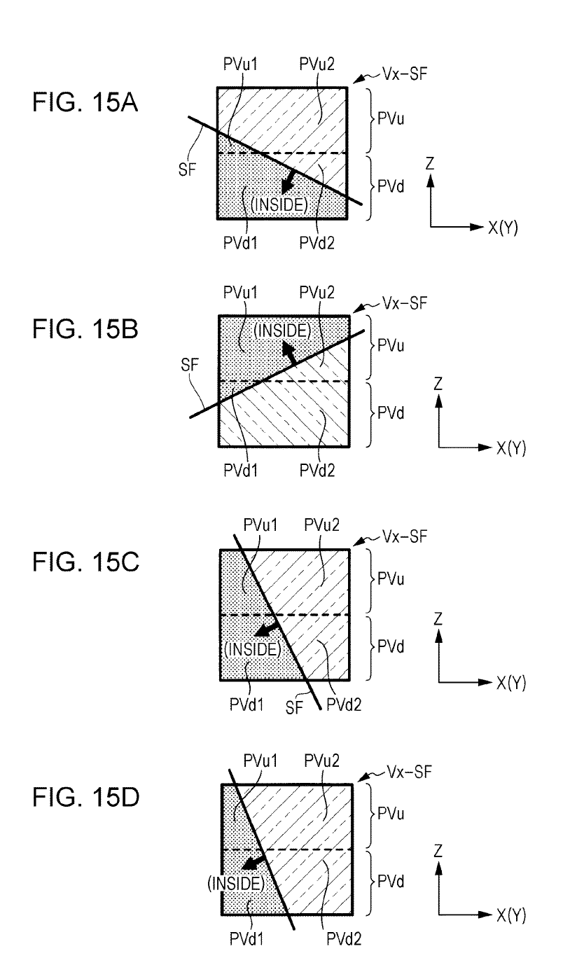

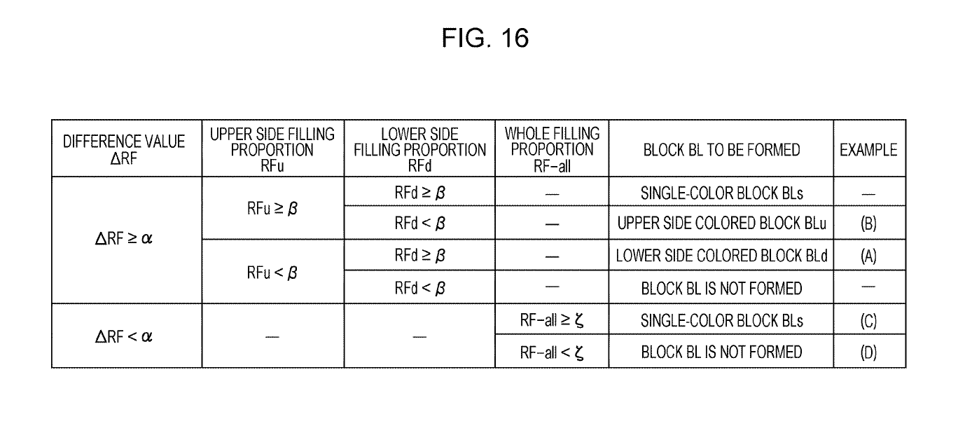

Next, in addition to FIGS. 14A to 14C, with reference to FIGS. 15A to 16, a description will be made of an example of calculation of a filling proportion RF performed by the designation data generation portion 93 in step S310 and an example of determination of the type of block BL performed by the designation data generation portion 93 in step S320.

FIGS. 15A to 15D are diagrams for explaining a filling proportion RF.

In step S310, as illustrated in FIGS. 15A to 15D, first, the designation data generation portion 93 divides the voxel upper portion PVu into a more inner portion PVu1 of the model than the outer surface SF and a more outer portion PVu2 of the model than the outer surface SF, and divides the voxel lower portion PVd into a more inner portion PVd1 of the model than the outer surface SF and a more outer portion PVd2 of the model than the outer surface SF.

In step S310, the designation data generation portion 93 calculates an upper side filling proportion RFu which is a proportion of a volume of the inner portion PVu1 occupying the voxel upper portion PVu, and a lower side filling proportion RFd which is a proportion of a volume of the outer portion PVd2 occupying the voxel lower portion PVd. The designation data generation portion 93 calculates a difference value ΔRF which is an absolute value of a difference between the upper side filling proportion RFu and the lower side filling proportion RFd.

In step S310, the designation data generation portion 93 calculates a whole filling proportion RF-all which is a proportion of a volume occupied by the more inner portions (the inner portions PVu1 and PVd1) than the outer surface SF to a total volume of the outer face voxel Vx-SF in the outer face voxel Vx-SF.

FIG. 16 is a diagram illustrates a correspondence relationship between a filling proportion RF of an outer face voxel Vx-SF and the type of block BL to be formed in the outer face voxel Vx-SF. In step S320, as illustrated in FIG. 16, the designation data generation portion 93 determines the type of block BL to be formed in an outer face voxel Vx-SF on the basis of a filling proportion RF.

Specifically, as illustrated in FIG. 16, first, the designation data generation portion 93 determines whether or not the difference value ΔRF is equal to or greater than a reference value a (where the reference value a is a real number which is greater than 0 and is equal to or smaller than 1) for each outer face voxel Vx-SF.

If it is determined that the difference value ΔRF is equal to or greater than the reference value a, the designation data generation portion 93 determines whether or not the upper side filling proportion RFu is equal to or more than a reference value and determines whether or not the lower side filling proportion RFd is equal to or more than the reference value β (where the reference value β is areal number which is greater than 0 and is equal to or smaller than 1).

As illustrated in FIG. 16, it is determined that the upper side filling proportion RFu is equal to or more than the reference value and the lower side filling proportion RFd is equal to or more than the reference value the designation data generation portion 93 determines a single-color block BLs as the type of block BL to be formed in the outer face voxel Vx-SF.

It is determined that the upper side filling proportion RFu is equal to or more than the reference value β, and the lower side filling proportion RFd is less than the reference value β, the designation data generation portion 93 determines an upper side colored block BLu as the type of block BL to be formed in the outer face voxel Vx-SF.

It is determined that the upper side filling proportion RFu is less than the reference value β, and the lower side filling proportion RFd is equal to or more than the reference value β, the designation data generation portion 93 determines a lower side colored block BLd as the type of block BL to be formed in the outer face voxel Vx-SF.

It is determined that the upper side filling proportion RFu is less than the reference value β, and the lower side filling proportion RFd is less than the reference value β, the designation data generation portion 93 determines that a block BL is not formed in the outer face voxel Vx-SF.

If it is determined that the difference value ΔRF is smaller than the reference value a, the designation data generation portion 93 determines whether or not the whole filling proportion RF-all is equal to or more than a reference value ζ (the reference value ζ is a real number which is greater than 0 and is smaller than 1).

As illustrated in FIG. 16, if it is determined that the whole filling proportion RF-all is equal to or more than the reference value ζ the designation data generation portion 93 determines a single-color block BLs as the type of block BL to be formed in the outer face voxel Vx-SF.

It is determined that the whole filling proportion RF-all is less than the reference value ζ, the designation data generation portion 93 determines that a block BL is not formed in the outer face voxel Vx-SF.

As mentioned above, as a result of determining the type of block BL according to FIG. 16, the lower side colored block BLd is determined to be formed in the outer face voxel Vx-SF in which the more inner portion than the outer surface SF is present so as to be biased to the voxel lower portion PVd as illustrated in FIG. 15A. In addition, the upper side colored block BLu is determined to be formed in the outer face voxel Vx-SF in which the more inner portion than the outer surface SF is present so as to be biased to the voxel upper portion PVu as illustrated in FIG. 15B.

For this reason, in the present embodiment, when compared with a case where a single-color block BLs is formed in an outer face voxel Vx-SF in the same way, it is possible to shape a solid object Obj which is colored in a shape similar to a shape of a model indicated by the model data Dat.

Meanwhile, an angle formed between the outer surface SF and the Z axis direction is smaller in the case illustrated in FIG. 15C or 15D than in the case illustrated in FIG. 15A or 15B. As illustrated in FIG. 15C or 15D, in a case where the outer face voxel Vx-SF in which an angle formed between the outer surface SF and the Z axis direction is small is divided into the voxel upper portion PVu and the voxel lower portion PVd, the colored portion PB1 is provided in one portion, and the colorless portion PB2 is provided in the other portion, an outer face block BL-SF provided in the outer face voxel Vx-SF is colored at a position which is different from that of the model indicated by the model data Dat. In this case, the colored portion PB1 is discontinuously formed such as a stripped pattern in a plurality of outer face blocks BL-SF which are continuously provided in the Z axis direction, and thus there is the possibility that a rough texture or a granular texture of a surface of a solid object Obj may be enhanced.

In contrast, in the present embodiment, as illustrated in FIG. 16, the separate block BLb (the lower side colored block BLd or the upper side colored block BLu) is formed on only an outer face voxel Vx-SF in which the difference value ΔRF is equal to or greater than the reference value α, and an angle formed between the outer surface SF and the Z axis direction is great. Therefore, as illustrated in FIG. 15C or 15D, it is possible to prevent the separate block BLb from being formed in the outer face voxel Vx-SF in which an angle formed between the outer surface SF and the Z axis direction is small, and thus to minimize a rough texture of the surface of the solid object Obj due to discontinuous formation of the colored portion PB1.

In the present embodiment, an angle formed between the outer surface SF and the Z axis direction is evaluated on the basis of the difference value ΔRF, but this is only an example, and an angle formed between the outer surface SF and the Z axis direction may be directly obtained.

In the present embodiment, it is determined whether or not the separate block BLb is to be formed on the basis of the difference value ΔRF, but, for example, it may be determined whether or not the separate block BLb is to be formed on the basis of whether or not an upper face or a lower face of a block BL constitutes a surface of a solid object Obj.

As described above, in step S330, the designation data generation portion 93 generates the designation data SD on the basis of the type of block BL determined in step S320 and the shaping body data FD. Specifically, in step S330, the designation data generation portion 93 generates the designation data SD for designating that a dot corresponding to the type of block BL determined in step S320 is to be formed in the outer face voxel Vx-SF.

If the designation data SD is supplied, the solid object shaping apparatus 1 forms the type of block BL designated by the designation data SD in each voxel Vx. In other words, the solid object shaping apparatus 1 according to the present embodiment can form a block BL in a first formation mode in which the single-color block BLs is formed in the voxel Vx, in a second formation mode in which the lower side colored block BLd is formed in the voxel Vx, and a third formation mode in which the upper side colored block BLu is formed in the voxel Vx.

More specifically, in step S160 illustrated in FIG. 10, if a formation mode is the first formation mode, the control portion 6 controls operations of the head unit 3 and the like so that the single-color block BLs is formed in the voxel Vx by ejecting coloring ink onto the voxel Vx from the head unit 3. If a formation mode is the second formation mode, the control portion 6 controls operations of the head unit 3 and the like so that the lower side colored block BLd is formed in the voxel Vx by ejecting coloring ink onto the voxel Vx from the head unit 3 and then ejecting clear ink. If a formation mode is the third formation mode, the control portion 6 controls operations of the head unit 3 and the like so that the upper side colored block BLu is formed in the voxel Vx by ejecting clear ink onto the voxel Vx from the head unit 3 and then ejecting coloring ink.

FIGS. 17A and 17B are diagrams for explaining an example of a solid object Obj (refer to FIG. 17A) indicated by the shaping body data FD and an example of a solid object Obj (refer to FIG. 17B) indicated by the designation data SD. FIGS. 17A and 17B are sectional views obtained when cutting a spherical solid object Obj corresponding to FIG. 11A on a plane parallel to the Z axis along a straight line γ-Γ. In FIGS. 17A and 17B, single-color blocks BLs constituting the colored layer L1 are hatched in a dark color, and blocks BL constituting the shield layer L2 and the inner layer L3 are hatched in a light color. In FIGS. 17A and 17B, among separate blocks BLb, the colored portion PB1 is hatched in a dark color, and the colorless portion PB2 is illustrated white.

In a case where a solid object Obj is shaped on the basis of the shaping body data FD, the surface of the solid object Obj is coby a plurality of single-color blocks BLs as illustrated in FIG. 17A. In this case, the solid object Obj has an irregular shape on the shape thereof due to the rectangular parallelepiped shape of the block BL. In other words, in this case, strictly speaking, the model indicated by the model data Dat and the solid object Obj have different shapes. The smooth spherical surface of the model indicated by the model data Dat cannot be accurately represented by the solid object Obj due to the shape difference.

On the other hand, in a case where the solid object Obj is shaped on the basis of the designation data SD which is generated by taking into consideration a filling proportion RF of an outer face voxel Vx-SF, the surface of the solid object Obj is constituted of a plurality of outer face blocks BL-SF, a plurality of lower side colored blocks BLd, and a plurality of upper side colored blocks BLu as illustrated in FIG. 17B. In this case, it is possible to shape the surface of the solid object Obj by using the type of block BL suitable for representing the model indicated by the model data Dat. For example, a projection of irregularities of the surface of the solid object Obj can be formed of the colorless portion PB2 which is highly transparent. In addition, it is possible to prevent the colored portion PB1 formed by using coloring ink from being formed so as to considerably protrude further outward than the outer surface SF of the model. In other words, as a result of shaping the solid object Obj on the basis of the designation data SD, even if the solid object Obj and the model have different shapes, the solid object Obj can be visually recognized as accurately representing the shape of the model.

The solid object shaping apparatus 1 according to the present embodiment forms a block BL in a formation mode corresponding to the designation data SD as described above. For this reason, the solid object shaping apparatus 1 according to the present embodiment forms the type of block BL suitable for representing a model indicated by the model data Dat, in an outer face voxel Vx-SF. Thus, it is possible to shape a smooth solid object Obj in which the possibility is minimized that irregularities of a surface of the solid object Obj may be visually recognized as roughness.

In the present embodiment, as illustrated in FIG. 17B, in the lower side colored block BLd related to the present embodiment, generally, the colored portion PM is located on a lower side (−Z direction) of the colorless portion PB2, the colored portion PM is located on an upper side (+Z direction) of the single-color block BLs, and the colorless portion PB2 constitutes the surface of the solid object Obj. In the upper side colored block BLu related to the present embodiment, generally, the colored portion PB1 is located on an upper side (+Z direction) of the colorless portion PB2, the colored portion PB1 is located on a lower side (−Z direction) of the single-color block BLs, and the colorless portion PB2 constitutes the surface of the solid object Obj. In other words, in the present embodiment, generally, in the separate block BLb, the colored face F1 of the colored portion PB1 is provided to be adjacent to the single-color block BLs in the Z axis direction, and the colorless face F2 of the colorless portion PB2 is provided to constitute the surface of the solid object Obj. For this reason, the colored portion PB1 formed by using coloring ink can be continuously provided, and thus the solid object Obj can be visually recognized as having a shape with a smooth surface.

Hereinafter, a condition in which the colored portion PB1 of the separate block BLb and the single-color block BLs are adjacent to each other in the Z axis direction and the colorless face F2 of the colorless portion PB2 of the separate block BLb constitutes the surface of the solid object Obj is referred to as a “first adjacency condition”.

In the present embodiment, as illustrated in FIG. 17B, generally, the lower side colored block BLd and the upper side colored block BLu are provided not to be adjacent to each other in the X axis direction or the Y axis direction. In other words, in the present embodiment, generally, the lower side colored block BLd and the upper side colored block BLu are provided not to be adjacent to each other in each shaping body LY[q].

Hereinafter, a condition in which the lower side colored block BLd and the upper side colored block BLu are provided not to be adjacent to each other in each shaping body LY[q] is referred to as a “second adjacency condition”.

In the present embodiment, as a result of generating the designation data SD on the basis of the filling proportion RF and shaping a solid object Obj on the basis of the designation data SD, generally, the solid object Obj satisfying the first adjacency condition and the second adjacency condition is formed.

However, such an aspect is an example, and the designation data generation portion 93 may generate designation data SD satisfying at least one of the first adjacency condition and the second adjacency condition in step S120.

3. Conclusion of Embodiment

As described above, in the present embodiment, the type of an outer face block BL-SF to be formed in an outer face voxel Vx-SF is determined on the basis of a filling proportion RF of the outer face voxel Vx-SF. For this reason, a solid object Obj can be colored in order to reduce the possibility that a difference between an outer surface SF of a model indicated by the model data Dat and a shape of the solid object Obj as a set of the blocks BL maybe visually recognized. Consequently, even if a solid object Obj is shaped so as to correspond to a model having a shape with a smooth surface, it is possible to shape the solid object Obj which does not cause a rough texture by reducing the possibility that irregularities of a surface of the solid object Obj may be visually recognized.

### B. MODIFICATION EXAMPLES

The above-described embodiment may be variously modified. Specific modification aspects will be exemplified below. Two or more aspects which are arbitrarily selected from the following examples may be combined with each other as appropriate within the scope which does not cause contradiction to each other.

In modification examples described below, elements whose operations or functions are equivalent to those in the embodiment are given the same reference numerals in the above description, and a detailed description thereof will be omitted as appropriate.

### Modification Example 1

In the above-described embodiment, the separate block BLb is formed in an outer face voxel Vx-SF in a case where a filling proportion RF satisfies a predetermined condition (for example, the condition illustrated in FIG. 16), but the invention is not limited to such an aspect. The separate block BLb may be formed only in a case where a filling proportion RF satisfies a predetermined condition in an edge voxel Vx-EG in which an edge block BL-EG constituting an edge portion of a solid object Obj is formed among outer face voxels Vx-SF.

Here, the edge voxel Vx-EG is an outer face voxel Vx-SF in which the edge block BL-EG is formed. The edge block BL-EG is a block BL in which two or more faces of six faces of a rectangular parallelepiped forming the block BL are exposed to the outside of the solid object Obj as a surface of the solid object Obj. Hereinafter, an outer face voxel Vx-SF which is not the edge voxel Vx-EG is referred to as a non-edge voxel Vx-PL, and a block BL formed in the non-edge voxel Vx-PL is a non-edge block BL-PL.

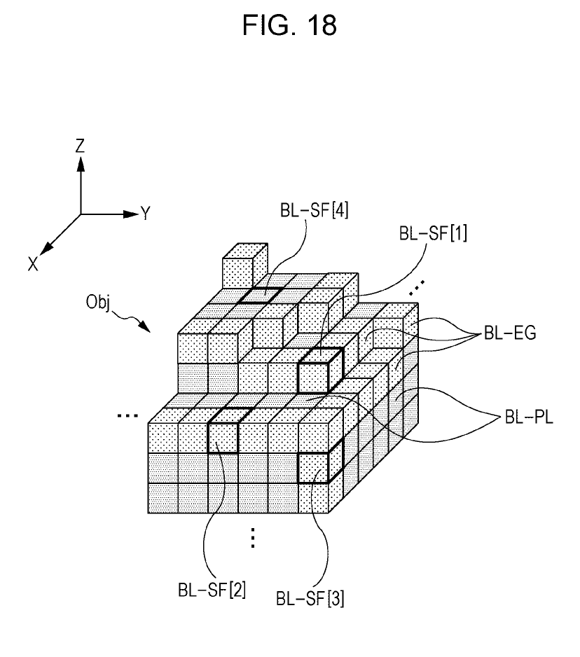

FIG. 18 is a diagram for explaining the edge block BL-EG formed in the edge voxel Vx-EG. In FIG. 18, the edge block BL-EG is represented as a block BL which is hatched in a light color, and the non-edge block BL-PL is represented as a block BL which is hatched in a dark color. For example, among outer face blocks BL-SF[1] to BL-SF[4] exemplified in FIG. 18, the outer face blocks BL-SF[1] to BL-SF[3] correspond to edge blocks BL-EG, and the outer face block BL-SF[4] corresponds to a non-edge block BL-PL.

The designation data generation portion 93 according to the present modification example extracts an edge voxel Vx-EG from a plurality of outer face voxels Vx-SF which are obtained as a result of discretizing a model indicated by the model data Dat. Next, the designation data generation portion 93 calculates a filling proportion RF of only the extracted edge voxel Vx-EG, and does not calculate filling proportions RF of the outer face voxels Vx-SF other than the edge voxel Vx-EG. The designation data generation portion 93 determines the type of block BL to be formed in the edge voxel Vx-EG on the basis of the calculated filling proportion RF.

As mentioned above, in the present modification example, it is possible to reduce a processing load related to calculation of a filling proportion RF compared with a case of calculating filling proportions RF of all outer face voxels Vx-SF as in the above-described embodiment.

Meanwhile, in a case where a separate block BLb is used as the type of outer face block BL-SF[3] exemplified in FIG. 18, there is the possibility that a horizontally stripped pattern may be generated on the surface of the solid object Obj. For this reason, calculation of a filling proportion RF may be limited to an edge voxel Vx-EG in which an edge block BL-EG is formed. In the edge block BL-EG, two or more faces of six faces of the edge block BL-EG are exposed to the outside of the solid object Obj as the surface of the solid object Obj, and one of the two or more faces is an upper face or a lower face of the edge block BL-EG. Consequently, it is possible to omit calculation of a filling proportion RF of an edge voxel Vx-EG in which a separate block BLb should not be formed, such as the edge voxel Vx-EG in which the outer face block BL-SF[3] exemplified in FIG. 18 is formed.

### Modification Example 2

In the above-described embodiment and modification example, as exemplified in FIG. 11B, the solid object Obj shaped by the solid object shaping apparatus 1 includes the outer region LOUT having the colored layer L1 and the shield layer L2, and the inner region LIN having the inner layer L3 and the hollow portion HL, but the invention is not limited to such an aspect, and the solid object shaping apparatus 1 may shape a solid object Obj having at least the colored layer L1.

In the solid object Obj, a clear layer which is formed by using clear ink and has a predetermined thickness may be provided outside the colored layer L1 so as to cover the colored layer L1. In this case, the clear layer is formed as a set of clear blocks BLc (an example of a “fourth unit shaping body”) which is formed by using clear ink. In addition, in this case, a surface of a solid object Obj is constituted of the clear layer, this is, the surface of the solid object Obj is constituted of the clear blocks BLc.

Hereinafter, a formation mode in which the solid object shaping apparatus 1 forms the clear blocks BLc in a voxel Vx is referred to as a fourth formation mode in some cases. In other words, if a formation mode is the fourth formation mode, the control portion 6 controls operations of the head unit 3 and the like so that the clear blocks BLc is formed in a voxel Vx by ejecting clear ink from the head unit 3 onto the voxel Vx.

In a case where a clear layer is provided outside the colored layer L1, the separate block BLb may be provided so that the colored face F1 thereof is adjacent to the surface block BLs in the Z axis direction, and the colorless face F2 thereof is adjacent to the clear blocks BLc in the Z axis direction. In other words, in a case where the clear layer is provided outside the colored layer L1, one of an upper face or a lower face of the separate block BLb is adjacent to the clear blocks BLc constituting the clear layer in the Z axis direction (instead of constituting the surface of the solid object Obj as in the above-described embodiment).

### Modification Example 3

In the above-described embodiment and modification examples, ink which can be ejected by the solid object shaping apparatus 1 is a total of six types of ink including five types of shaping ink and a single type of support ink, but the invention is not limited to such an aspect. For example, the solid object shaping apparatus 1 may eject at least two types of ink including a single type of coloring ink (an example of a “first liquid” which is hereinafter referred to as “first ink”), and ink (an example of a “second liquid” which is hereinafter referred to as “second ink”) which has an amount of colorant components which is smaller than an amount of colorant components of the coloring ink and is thus highly transparent.

Here, the second ink may be coloring ink and clear ink. Here, if the second ink is coloring ink, the second ink preferably contains a colorant component having the same color as a color of the first ink.

### Modification Example 4

In the above-described embodiment and modification examples, the designation data generation portion 93 generates the shaping body data FD defining a set of voxels Vx which includes the entire model indicated by the model data Dat (refer to FIG. 17A), but the invention is not limited to such an aspect. The designation data generation portion 93 may generate the shaping body data FD indicating a set of voxels Vx which does not include a part of the model indicated by the model data Dat.

In this case, the designation data generation portion 93 may provide an outer face voxel Vx-SF so as to including a model indicated by the model data Dat on the outside of a set of voxels Vx indicated by the shaping body data FD. In addition, in this case, the outer face voxel Vx-SF may include both the inside and the outside of an outer surface SF of the model.

### Modification Example 5

In the above-described embodiment and modification examples, the process of specifying an outer face voxel Vx-SF in step S300, the process of calculating a filling proportion RF in step S310, and the process of specifying the type of block BL in step S320 are performed by the designation data generation portion 93 provided in the host computer 9, but the invention is not limited to such an aspect, and the processes may be performed by the control portion 6. In a case where the processes in steps S300 to S320 are performed by the control portion 6, the designation data SD generated by the designation data generation portion 93 may designate formation of a dot with the same content as the content indicated by the shaping body data FD.

In other words, even in a case where the designation data SD designates that a dot a surface block BLs having a color designated by the model data Dat is formed in a voxel Vx, if the voxel Vx corresponds to an outer face voxel Vx-SF, and a filling proportion RF of the voxel Vx satisfies a predetermined condition, the control portion 6 according to the present modification example may control operations of the head unit 3 and the like so that a separate block BLb is formed in the voxel Vx. In this case, the host computer 9 may supply the designation data SD and the model data Dat to the control portion 6.

### Modification Example 6

In the above-described embodiment and modification examples, the solid object shaping apparatus 1 shapes the solid object Obj by laminating the shaping body LY which is formed by curing shaping ink, but the invention is not limited to such an aspect. For example, powders which are spread in a layer state may be hardened by curable shaping ink so as to form the shaping body LY, and the solid object Obj may be shaped by laminating the formed shaping body LY.

In this case, the solid object shaping apparatus 1 may include a powder layer forming portion (not illustrated) which forms a powder layer PW by spreading a powder on the shaping platform 45 with a predetermined thickness AZ, and a powder removing portion (not illustrated) which removes powders (powders other than powders hardened by the shaping ink) which does not constitute a solid object Obj after forming the solid object Obj. Hereinafter, a powder layer PW for forming a shaping body LY[q] is referred to as a powder layer PW[q].

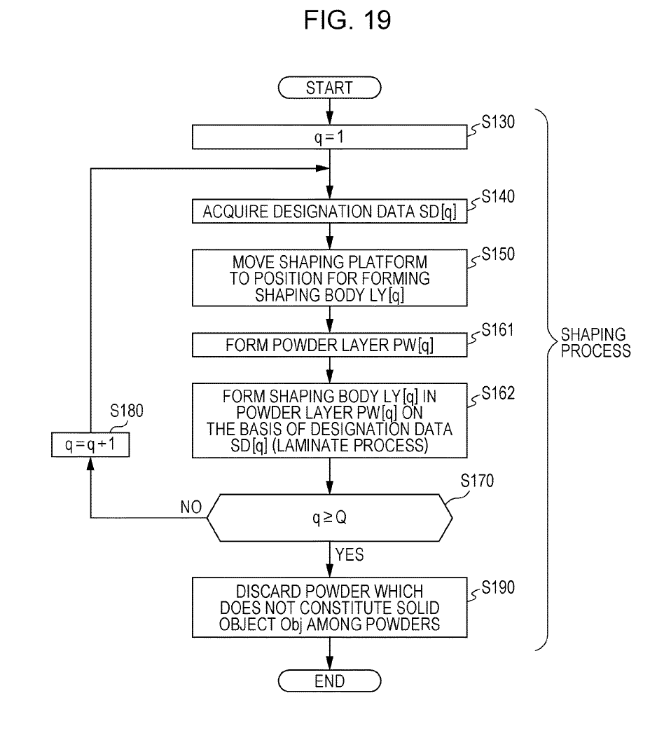

FIG. 19 is a flowchart illustrating an example of an operation of the solid object shaping system 100 in a case where a shaping process according to the present modification example is performed. The shaping process according to the present modification example, illustrated in FIG. 19, is the same as the shaping process according to the embodiment illustrated in FIG. 10 except that processes in steps S161 and S162 are performed instead of step S160, and a process in step S190 is performed if a determination result is affirmative instep S170.

As illustrated in FIG. 19, the control portion 6 according to the present modification example controls an operation of each portion of the solid object shaping apparatus 1 so that the powder layer forming portion forms the powder layer PW[q] (S161).

The control portion 6 according to the present modification example controls an operation of each portion of the solid object shaping apparatus 1 so that the shaping body LY[q] is formed by forming a dot in the powder layer PW[q] on the basis of the designation data SD[q] (S162). Specifically, first, in step S162, the control portion 6 generates the waveform designation signal SI by using the designation data SD[q], and controls an operation of the head unit 3 by using the generated waveform designation signal SI so that shaping ink or support ink is ejected onto the powder layer PW[q]. Next, the control portion 6 controls an operation of the curing unit 61 so that powders of a portion of the powder layer PW[q] in which a dot is formed are hardened by curing the dot formed by the ink ejected on the powder layer PW[q]. Consequently, powders of the powder layer PW[q] can be hardened by ink, and thus the shaping body LY[q] can be formed.

The control portion 6 according to the present modification example controls an operation of the power removing portion so that powders which do not constitute the solid object Obj are removed (S190).

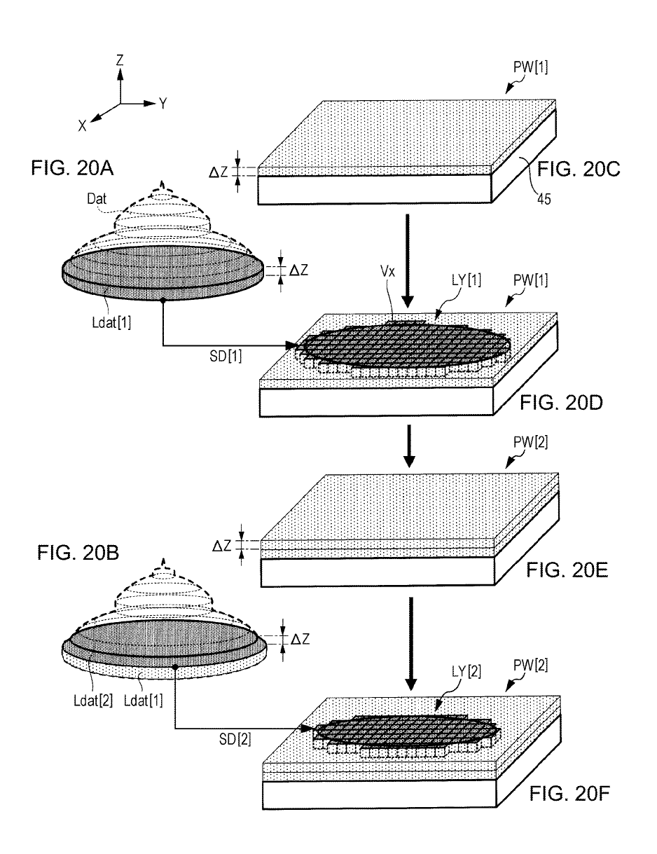

FIG. 20 is a diagram for explaining a relationship among the model data Dat, the section model data Ldat[q], the designation data SD[q], the powder layer PW[q], and the shaping body LY[q] according to the present modification example.

FIGS. 20(A) and 20(B) are the same as FIGS. 2(A) and 2(B), and exemplify section model data Ldat[1] and Ldat[2]. Also in the present modification example, the section model data Ldat[q] is generated by slicing a model of a solid object Obj indicated by the model data Dat, the designation data SD[q] is generated on the basis of the section model data Ldat[q], and the shaping body LY[q] is formed by a dot which is formed on the basis of the waveform designation signal SI, the waveform designation signal SI being generated by using the designation data SD[q]. Hereinafter, with reference to FIGS. 20(C) to 20(F), a description will be made of formation of the shaping body LY[q] according to the present modification example by exemplifying the shaping bodies LY[1] and LY[2].

As illustrated in FIG. 20(C), the control portion 6 controls an operation of the powder layer forming portion so that a powder layer PW[1] with a predetermined thickness AZ is formed before forming the shaping body LY[1] (refer to the above-described step S161).

Next, as illustrated in FIG. 20(D), the control portion 6 controls an operation of each portion of the solid object shaping apparatus 1 so that the shaping body LY[1] is formed in the powder layer PW[1] (refer to the above-described step S162). Specifically, first, the control portion 6 controls an operation of the head unit 3 on the basis of the waveform designation signal SI which is generated by using the designation data SD[1], and thus dots are formed by ejecting ink onto the powder layer PW[1]. Next, the control portion 6 controls an operation of the curing unit 61 so that the dots formed in the powder layer PW[1] are cured, and thus the shaping body LY[1] is formed by hardening powders of a portion in which the dots are formed.

Thereafter, as illustrated in FIG. 20(E), the control portion 6 controls the powder layer forming portion so that a powder layer PW[2] with the predetermined thickness AZ is formed on the powder layer PW[1] and the shaping body LY[1]. As illustrated in FIG. 20(F), the control portion 6 controls an operation of each portion of the solid object shaping apparatus 1 so that the shaping body LY[2] is formed.

As mentioned above, the control portion 6 controls execution of the laminate process of forming the shaping body LY[q] in the powder layer PW[q] on the basis of the waveform designation signal SI which is generated by using the designation data SD[q], and shapes the solid object Obj by laminating the shaping body LY[q].

### Modification Example 7

In the above-described embodiment and modification examples, ink ejected from the ejecting portion D is curable ink such as ultraviolet curable ink, but the invention is not limited to such an aspect, and the ink may be ink made of a thermoplastic resin or the like.

In this case, the ink is preferably ejected in a state of being heated in the ejecting portion D. For example, the ejecting portion D according to the present modification example may perform so-called thermal type ink ejection in which a heat source (not illustrated) provided in the cavity 320 generates heat so as to generate foams in the cavity 320, and thus ink is ejected due to an increase in pressure inside the cavity 320.

In this case, the ink ejected from the ejecting portion D is cooled by ambient air and is thus cured. Therefore, the solid object shaping apparatus 1 may not include the curing unit 61.

### Modification Example 8

In the above-described embodiment and modification examples, sizes of dots which can be formed by the solid object shaping apparatus 1 are two kinds of sizes such as a small dot and a large dot, but the invention is not limited to such an aspect, and sizes of dots which can be formed by the solid object shaping apparatus 1 may be two or more kinds of sizes.

For example, the head unit 3 may eject three types of dots with different sizes, such as a small dot filling ⅓ of a size of a block BL, a medium dot filling ⅔ of the size of the block BL, and a large dot filling the entire block BL. In this case, a shape of a portion of a solid object Obj which is colored by coloring ink can be caused to accurately track a shape of a model indicated by the model data Dat.

### Modification Example 9

In the above-described embodiment and modification examples, the designation data generation portion 93 is provided in the host computer 9, but the invention is not limited to such an aspect, and the designation data generation portion 93 may be provided in the solid object shaping apparatus 1. For example, the designation data generation portion 93 may be installed as a functional block which is realized when the control portion 6 operates according to a control program. In other words, the designation data generation portion 93 may be provided in the control portion 6.

In a case where the solid object shaping apparatus 1 includes the designation data generation portion 93, the solid object shaping apparatus 1 may generate the designation data SD on the basis of the model data Dat which is supplied from an external device of the solid object shaping apparatus 1, and may shape a solid object Obj on the basis of the waveform designation signal SI which is generated by using the generated designation data SD.

### Modification Example 10

In the above-described embodiment and modification examples, the solid object shaping system 100 includes the model data generation portion 92, but the invention is not limited to such an aspect, and the solid object shaping system 100 may not include the model data generation portion 92. In other words, the solid object shaping system 100 may shape a solid object Obj on the basis of the model data Dat supplied from an external device of the solid object shaping system 100.

### Modification Example 11

In the above-described embodiment and modification examples, the driving waveform signal Com is a signal having the waveforms PL1 and PL2, but the invention is not limited to such an aspect. For example, the driving waveform signal Com may be any signal as long as the signal has a waveform which can cause ink in an amount corresponding to a dot having at least two kinds of sizes to be ejected from the ejecting portion D. For example, the driving waveform signal Com may have waveforms depending on the type of ink.

In the above-described embodiment and modification examples, the number of bits of the waveform designation signal SI[m] is 2 bits, but the invention is not limited to such an aspect. The number of bits of the waveform designation signal SI[m] may be defined as appropriate depending on the number of kinds of sizes of dots formed by ink ejected from the ejecting portion D.

The entire disclosure of Japanese Patent Application No: 2015-030153, filed Fe. 19, 2015 is expressly incorporated by reference herein.

1. A solid object shaping apparatus comprising:
a head unit that can eject a plurality of types of liquids including a first liquid, and a second liquid having an amount of colorant components which is smaller than an amount of colorant components of the first liquid; and
a curing unit that cures the liquid ejected from the head unit,
wherein a unit shaping body is formed by using the cured liquid, and a solid object is shaped by using the plurality of unit shaping bodies, and
wherein the unit shaping body can be formed in a plurality of formation modes including
a first formation mode in which the first liquid is ejected from the head unit, and thus the unit shaping body is formed by using the cured first liquid;
a second formation mode in which the first liquid is ejected from the head unit, then the second liquid is ejected, and thus the unit shaping body is formed by using the cured first liquid and the cured second liquid; and
a third formation mode in which the second liquid is ejected from the head unit, then the first liquid is ejected, and thus the unit shaping body is formed by using the cured second liquid and the cured first liquid.

2. The solid object shaping apparatus according to claim 1,
wherein the unit shaping body formed in the second formation mode or the third formation mode is provided with a first face which is formed by using the cured first liquid, and a second face which is an opposite face to the first face and is formed by using the cured second liquid, and
wherein the first face is adjacent to a unit shaping body which is formed in the first formation mode, and the second face constitutes a surface of the solid object.

3. The solid object shaping apparatus according to claim 1,
wherein the unit shaping body can be formed in a plurality of formation modes including a fourth formation mode in which the second liquid is ejected from the head unit, and thus the unit shaping body is formed by using the cured second liquid,
wherein the unit shaping body formed in the second formation mode or the third formation mode is provided with a first face which is formed by using the cured first liquid, and a second face which is an opposite face to the first face and is formed by using the cured second liquid, and
wherein the first face is adjacent to a unit shaping body which is formed in the first formation mode, and the second face is adjacent to a unit shaping body which is formed in the fourth formation mode.

4. The solid object shaping apparatus according to claim 1,
wherein the solid object is shaped by laminating a shaping layer formed of the plurality of unit shaping bodies in an upper direction,
wherein a unit shaping body formed in the second formation mode is formed on an upper side of a unit shaping body formed in the first formation mode, and
wherein the unit shaping body formed in the first formation mode is formed on an upper side of a unit shaping body formed in the third formation mode.

5. The solid object shaping apparatus according to claim 1,
wherein the solid object is shaped by laminating a shaping layer formed of the plurality of unit shaping bodies, and
wherein a unit shaping body formed in the second formation mode is not adjacent to a unit shaping body formed in the third formation mode.

6. A control method for a solid object shaping apparatus which includes a head unit that can eject a plurality of types of liquids including a first liquid, and a second liquid having an amount of colorant components which is smaller than an amount of colorant components of the first liquid; and a curing unit that cures the liquid ejected from the head unit, and which forms a unit shaping body by using the cured liquid, and shapes a solid object by using the plurality of unit shaping bodies, the method comprising:
controlling the head unit so as to form the unit shaping body in a plurality of formation modes including
a first formation mode in which the first liquid is ejected from the head unit, and thus the unit shaping body is formed by using the cured first liquid;
a second formation mode in which the first liquid is ejected from the head unit, then the second liquid is ejected, and thus the unit shaping body is formed by using the cured first liquid and the cured second liquid; and
a third formation mode in which the second liquid is ejected from the head unit, then the first liquid is ejected, and thus the unit shaping body is formed by using the cured second liquid and the cured first liquid.

7. A control program for a solid object shaping apparatus which includes a head unit that can eject a plurality of types of liquids including a first liquid, and a second liquid having an amount of colorant components which is smaller than an amount of colorant components of the first liquid; a curing unit that cures the liquid ejected from the head unit; and a computer, and which forms a unit shaping body by using the cured liquid, and shapes a solid object by using the plurality of unit shaping bodies, the program causing the computer function as:
a control portion that controls the head unit so as to form the unit shaping body in any one of a plurality of formation modes including
a first formation mode in which the first liquid is ejected from the head unit, and thus the unit shaping body is formed by using the cured first liquid;
a second formation mode in which the first liquid is ejected from the head unit, then the second liquid is ejected, and thus the unit shaping body is formed by using the cured first liquid and the cured second liquid; and
a third formation mode in which the second liquid is ejected from the head unit, then the first liquid is ejected, and thus the unit shaping body is formed by using the cured second liquid and the cured first liquid.
